(19) United States
(12) Patent Application Publication
(10) Pub. No.: US 2026/0087319 A1
(43) Pub. Date: Mar. 26, 2026

(54) CONVOLUTION HIDENN-TENSOR DECOMPOSITION FOR MANUFACTURING SIMULATION, PERFORMANCE PREDICTION, AND TOPOLOGY OPTIMIZATION OF MULTISCALE MATERIAL SYSTEMS

(71) Applicant: NORTHWESTERN UNIVERSITY, Evanston, IL (US)

(72) Inventors: Wing Kam Liu, Oak Brook, IL (US); Ye Lu, Evanston, IL (US); Hengyang Li, Evanston, IL (US); Chanwook Park, Evanston, IL (US); Satyajit Mojumder, Evanston, IL (US); Sourav Saha, Evanston, IL (US); Xiaoyu Xie, Evanston, IL (US)

(21) Appl. No.: 19/110,163

(22) PCT Filed: Sep. 18, 2023
(86) PCT No.: PCT/US2023/032981

§ 371 Date: Mar. 10, 2025

Related U.S. Application Data
(60) Provisional application No. 63/407,444, filed on Sep. 16, 2022.

(51) Int. Cl. G06N 3/0464

(52) U.S. Cl. CPC G06N 3/0464

(57) ABSTRACT

Convolution-Hierarchical Deep-learning Neural Network-Tensor decomposition (C-HiDeNN-TD) has four features: (1) Tensor decomposition breaking down the whole design into small tractable problems; (2) Convolution built-in filter to increase accuracy without adding extra DoFs; (3) Convolution built-in filter can avoid checkerboard pattern; (4) Design can have arbitrary smoothness without adding extra DoFs.

### CROSS-REFERENCE TO RELATED PATENT APPLICATION

This application claims priority to and the benefit of U.S. Provisional Patent Application Ser. No. 63/407,444, filed Sep. 16, 2022, which is incorporated herein in its entirety by reference.

### FIELD OF INVENTION

The present disclosure relates to the technical field of Convolution-Hierarchical Deep-learning Neural Network-Tensor Decomposition (C-HiDeNN-TD) which pertains to a method, algorithm, and computer program employed in engineering analysis and design optimization.

### BACKGROUND OF THE INVENTION

The background description provided herein is for the purpose of generally presenting the context of the present invention. The subject matter discussed in the background of the invention section should not be assumed to be prior art merely as a result of its mention in the background of the invention section.

Topology optimization is a computational design approach that aims to find the optimal layout or distribution of material within a given design domain. It involves discretizing the domain into smaller elements and iteratively adjusting the material distribution based on predefined objectives and constraints. The goal is to achieve designs that are structurally efficient, lightweight, and meet specific performance criteria. Topology optimization has applications in various fields such as engineering, architecture, and manufacturing, enabling the creation of innovative and optimized structures.

Most TO approaches use finite element analysis (FEA) to simulate the performance of a design during the optimization and there are some challenges related to the usage of classical FEA for TO:
1) Most FEA use linear approximation to the solution field which is less accurate.
2) FEA necessitates carefully refined mesh that dramatically increases the computation cost.
3) Design and optimization of the multiscale structure is extremely limited due to high computation cost.

The major concern is the usage of FEA for solving and analyzing physics problems, which is less accurate and computationally expensive.

On the other side, the field of engineering analysis is undergoing a transition from Engineering Software 1.0 (classical numerical methods like finite element analysis (FEA) which solves systems of linear equations) to Engineering software 2.0 (methods based on physics-informed neural networks (PINNs) that solve optimization problems). The key advantage of utilizing Engineering Software 2.0 lies in the application of automatic differentiation to minimize the Lagrangian form of any governing equations. Since the pioneering work reported in 2017, fully connected PINNs for solving forward and inverse partial differential equations (PDEs) have prospered. PINNs have found applications in various domains of engineering analysis as well as inverse engineering design such as topology optimization (TO).

One of the unresolved challenges of PINNs is that the efficiency of PINNs still lags behind classical numerical methods like FEA. In PINN, regardless of their neural network structure, all weights and biases are trainable and mostly initialized randomly. Conversely, FEA utilizes predefined functional approximations employing Lagrange interpolating polynomials.

Therefore, it is desired to systematically construct a neural network architecture that takes advantage of well-developed FEA or meshfree theories in order to enhance computational efficiency. This efficient neural network has a huge potential of resolving the aforementioned challenges of the classical FEA-based TO.

### SUMMARY OF INVENTION

In light of the foregoing, this invention discloses a forward engineering analysis method of Convolution-Hierarchical Deep-learning Neural Network-Tensor Decomposition (C-HiDeNN-TD) for solving a physics problem using more than one graphics processing units (GPUs) or tensor processing units (TPU) combined with multiple CPUs. The method comprises (1) providing a plurality of modes and at least one C-HiDe. VN parameter; (2) computing at least one C-HiDeNN function for each of the plurality of modes based on the at least one C-HiDeNN parameter; (3) solving the physics problem for each of the plurality of modes based on the C-HiDeNN function; wherein the at least one C-HiDeNN function comprises a spatial C-HiDeNN function; wherein the C-HiDeNN parameter comprises at least one of a patch size s, a dilation parameter a, and reproducing order p.

In one embodiment, the at least one C-HiDeNN function comprises at least one of a material C-HiDeNN function, a process C-HiDeNN function, and a temporal C-HiDeNN function.

In one embodiment, the spatial C-HiDeNN function is

$${u}_{{p}^{x}}^{( m )} ( {p}^{x} ) .$$

In one embodiment, the material C-HiDeNN function is

$${u}_{{P}^{M}}^{( m )} ( {p}^{M} ) .$$

In one embodiment, the process C-HiDeNN function is

$${u}_{{P}^{P}}^{( m )} ( {p}^{P} ) .$$

In one embodiment, the temporal C-HiDeNN function is

$${u}_{{P}^{t}}^{( m )} ( {p}^{t} ) .$$

In one embodiment, steps (2-3) are parallelizable with the more than one GPUs or the tensor processing units (TPU) combined with the multiple CPUs.

In one embodiment, step (3) comprises an alternating fixed-point (API) iteration or a minimization of loss function.

In one embodiment, the loss function is uniquely defined based on a physics character of the physics problem.

In another aspect of the invention, a method for solving a concurrent multiscale topology optimization problem using Convolution-Hierarchical Deep-learning Neural Network-Tensor Decomposition (C-HiDeNN-TD) to produce a final design comprises (1) providing at least one engineering target property; at least one design constraint, at least one material choice, a number of scales to be solved; a design parameter; (2) providing an initial domain mesh for each scale; (3) formulating a multi-objective function and a convergence criteria based on the at least one engineering target property; the at least one design constraint; and the at least one material choice; (4) performing a concurrent multiscale engineering simulation using a C-HiDeNN-TD parameter; (5) analyzing a sensitivity character of the concurrent multiscale topology optimization problem; (6) updating the design parameter; and (7) outputting the final design when the convergence criteria is fulfilled; wherein the C-HiDeNN-TD parameter comprises at least one of a patch size s, a dilation parameter a, and reproducing order p.

In one embodiment, the target property comprises at least one of system compliance, stiffness or rigidity, Eigenfrequency or natural frequency, thermal performance, fluid flow characteristics, and electromagnetic characteristics.

In one embodiment, the design constraint comprises at least one of volume fraction, stress or strength constraints, displacement or deformation constraints, manufacturing constraints, buckling or stability constraints, frequency and resonance constraints.

In one embodiment, the material choice comprises at least one of metal, ceramic, polymer, and composites.

In one embodiment, the multi-objective function in step (3) is assigned to different regions in each scale.

In one embodiment, the concurrent multiscale engineering simulation in step (5) comprises conducting an engineering analysis in each scale concurrently.

In one embodiment, the engineering analysis in each scale is conducted using the C-HiDeNN-TD.

In one embodiment, the sensitivity analysis in step (5) is performed in parallel.

In one embodiment, steps (6-7) are performed in parallel.

In one embodiment, a C-HiDeNN-TD build-in filter is used to output a smooth design surface.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 illustrates an overview of C-HiDeNN and C-HiDeNN-TD theory and computational implementation with potential application areas and demonstration of material systems design and performance prediction.

FIG. 2 illustrates a chart of accuracy and convergence plot of FEM and C-HiDeNN-FEM for 1D Poisson's problem. Numbers on the graph is the convergence rate, and p is the reproducing polynomial order of the patch function.

FIG. 3 illustrates a diagram showing functional approximation spaces for different methods with accuracy estimates.

FIG. 4 illustrates C-HiDeNN-TD²-SCA for concurrent multiscale optimization, in which the reduction of DOFs when using TD, reduces the computational effort ten order of magnitude.

FIG. 5 illustrates C-HiDeNN-TD in reducing a large-scale supercomputer-based TO problem that requires 9,000 CPU hours to a computationally affordable problem with single PC and only 44 CPU hours.

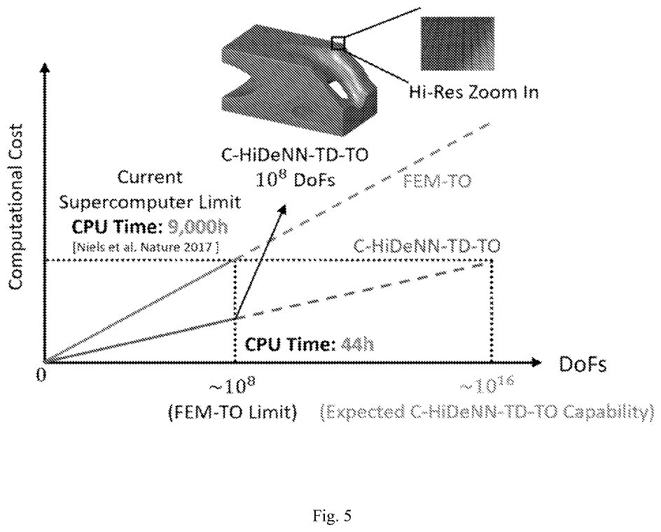

FIG. 6 illustrates example (a) Polycarbonate/Short Carbon Fiber (PC/SCF) composite manufactured using fused filament fabrication process with nozzle temperature 260° C., layer thickness 0.2 mm and hatch spacing of 0.3 mm; example (b) A single filament from the printed sample showing defects (voids) and SCF; and example (c) A computational microstructure model with voids and SCF distribution.

FIG. 7 illustrates an additively manufactured drone structure with different weight reductions designed with different layer orientations at the meso-scale level; in particular, panel (a) shows a topology optimization design of an additively manufacturable drone structure, panel (b) shows meso- and micro-scale response of the materials microstructure under a tensile loading condition; and panel (c) shows different mesoscale layer orientations design stress-strain response for a microstructure having 2% voids defects.

FIG. 8 illustrates HiDeNN-FEM formulation for a 1-D Poisson's problem.

FIG. 9 illustrates the nodal patch domain

$$( {A}_{s}^{i} )$$

on a 2-D, 8×8 element mesh. s is the patch size and the domains are colored by the patch size.

FIG. 10 illustrates a labeled graph of five nodes (aka vertices) and their connectivity relationships displayed with edges; an adjacency matrix based on a 4×4 elements (or 5×5 nodes) uniform mesh; and the first row of A\hat{ }2 where we can see components 0, 1, 2, 5, 6, 7, 10, 11, and 12 are non-zero.

FIG. 11 illustrates C-HiDeNN formulation for a 1-D Poisson's problem.

FIG. 12 illustrates C-HiDeNN shape function of element e; for 2-D 4-node (a) and 3-D 8-node (b) elements.

FIG. 13 illustrates a flowchart of C-HiDeNN-TD algorithm using alternating fixed-point iteration.

FIG. 14 illustrates a flowchart of C-HiDeNN-TD algorithm using minimization of a loss function.

FIG. 15 illustrates a flowchart of algorithm of C-HiDeNN-TD for topology optimization.

FIG. 16 illustrates a flowchart of C-HiDeNN-TD for concurrent multiscale topology optimization.

FIG. 17 illustrates C-HiDeNN-TD extends the computational capability and enables high resolution.

FIG. 18 illustrates C-HiDeNN-TD has built-in filters to avoid checkerboard. (a) SIMP-TO approach, an extra filter is needed to control the length-scale and avoid a checkerboard pattern. (b) C-HiDeNN-TD-TO approach, no extra filter is needed. The length-scale control can be done by choosing the patch size s, polynomial order p, and dilation parameter a.

FIG. 19 illustrates C-HiDeNN-TD enables the design having arbitrary smoothness without adding extra DoFs.

FIG. 20 illustrates C-HiDeNN-TD achieves higher accuracy with lower loss function of the topology optimization without adding extra DoFs.

FIG. 21 illustrates the comparison between a feed forward neural network (FFNN) and a piecewise neural network for regressing a dataset.

FIG. 22 illustrates the C-HiDeNN-AI system for online monitoring.

FIG. 23 compares the structure between C-HiDeNN trainer and solver.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this invention will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments and optional features, modification and variation of the concepts herein disclosed may be resorted to by those skilled in the art, and that such modifications and variations are considered to be within the scope of this invention as defined by the appended claims.

Whenever a range is given in the specification, for example, a temperature range, a time range, or a composition or concentration range, all intermediate ranges and subranges, as well as all individual values included in the ranges given are intended to be included in the invention. It will be understood that any subranges or individual values in a range or subrange that are included in the description herein can be excluded from the claims herein.

It will be understood that, as used in the description herein and throughout the claims that follow, the meaning of “a”, “an”, and “the” includes plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation depicted in the figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

It will be further understood that the terms “comprises” and/or “comprising”, or “includes” and/or “including”, or “has” and/or “having”, or “carry” and/or “carrying”, or “contain” and/or “containing”, or “involve” and/or “involving”, “characterized by”, and the like are to be open-ended, i.e., to mean including but not limited to. When used in this disclosure, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the invention, and will not be interpreted in an idealized or overly formal sense unless expressly so defined herein.

As used in the disclosure, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated.

As used in the disclosure, the phrase “at least one of A, B, and C” should be construed to mean a logical (A or B or C), using a non-exclusive logical OR. As used herein, the term “and/or” includes any and all combinations of one or more of the associated listed items.

The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in different order (or concurrently) without altering the principles of the invention.

The present invention establishes a novel computational theory C-HiDeNN and C-HiDeNN-TD to solve extremely large-scale Computational Science and Engineering (CS&E) problems that are computationally intractable and/or inaccessible with the current physics-based approaches. This new capability is enabled by integrating robust physics-based models with convolution and deep neural network (DNN) that are applied at hierarchical scales of interest.

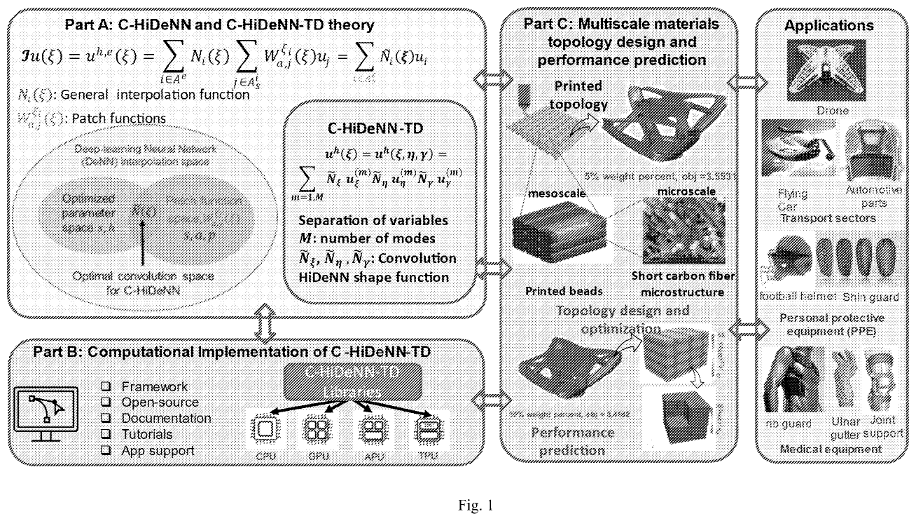

The present invention is divided into three parts as shown in FIG. 1.

In particular, according to FIG. 1, the Part A focuses on theoretical development of C-HiDeNN-TD based on C-HiDeNN, more specifically the three key mathematical science ingredients: 1) Hierarchical Deep-learning Neural Network (HiDeNN), which is a generalization of the universal approximation for solving mechanical science problems; 2) Convolution, which is a fundamental mathematical operation widely used in signal and image processing, and in different branches of pure and applied mathematics; and 3) Tensor Decomposition, a generalization of low-rank matrix decomposition for reducing the high-dimensional computational degrees of freedom.

In Part B, the present invention develops highly scalable and efficient computational implementations of C-HiDeNN-TD. This is accomplished by taking the advantage of inherent parallel data-structure of the convolution operation with modern high-performance computing (HPC) hardware such as multi-core CPU, Graphics Processing Unit (GPU), Tensor Processing Unit (TPU), Accelerated Processing Unit (APU), and data-science algorithms to develop a robust C-HiDeNN-TD solver. This can be applied to general class of extremely large-scale CS&E problems as shown in FIG. 1.

In Part C, the present invention demonstrates the capability of C-HiDeNN-TD methods in solving CS&E problems that are otherwise computationally intractable or inaccessible. In this context, the present invention has shown that C-HiDeNN-TD overcomes the critical computational barrier for multiscale optimization of additively manufactured materials system.

The intellectual merit of the present invention is reflected in the following four aspects. First, the proposed C-HiDeNN and C-HiDeNN-TD theory is transformative in that it establishes an entirely new methodology of incorporating the problem physics into the universal interpolation function using powerful feature extraction techniques based on convolution and deep neural network. This represents a significant advance over the conventional interpolations such as finite element approximations that are based on polynomial-based expansion. The unique approach of C-HiDeNN in building physics-based approximation provides the theoretical foundation for both superior accuracy and convergence compared to existing approaches. Second, general DNN applications require significant efforts in tuning the hyperparameters for optimal performance and recalibration if the problem statement is changed. C-HiDeNN overcomes these limitations by establishing a systematic approach to construct the optimal universal approximation of solutions of arbitrary order and smoothness. As a result, it addresses a critical gap in enabling CS&E applications using DNN. Third, both the proposed algorithmic developments based on tensor decomposition (TD) and HPC hardware implementations lead to a new generation of computational solver capable of addressing problems with unprecedented scales and resolutions (e.g., ˜10 billion DOFs in a desktop computer with GPU), thereby enabling new scientific discoveries. Fourth, the specific application of C-HiDeNN-TD in multiscale optimization of additively manufactured materials system represents a novel attempt to advance the domain knowledge in the field of material systems design, optimization, and performance prediction of additively manufactured parts. Examples include composites and metal parts used in drones, flying cars, personal protective sports gear, medical equipment and etc. according to FIG. 1. Therefore, understandings derived from the present invention is expected to benefit the broader CS&E applications.

### Fully Connected Feed Forward Neural Networks (FFNNs) and Piecewise Linear Regression

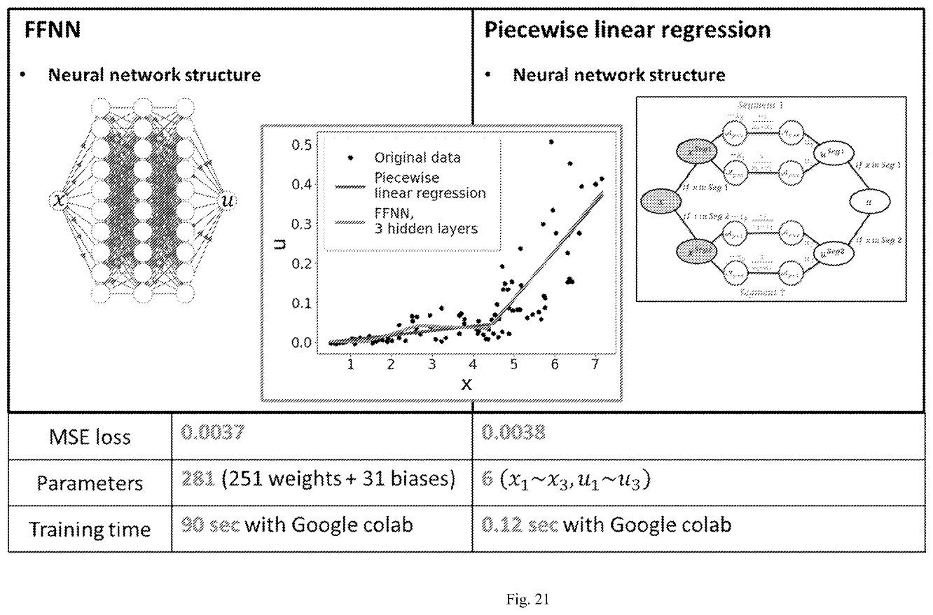

In one embodiment, the present invention discloses the key motivation of the convolution hierarchical deep-learning neural network (C-HiDeNN) theory. Feed forward neural network (FFNN) is the most basic neural network structure for a regression problem, enabled by the universal approximation theory. That is, a deep enough FFNN can approximate any functional relationship if the neural network is well trained with a large number of datasets. However, a fully connected deep neural network necessitates a significant number of training parameters called weights and biases, limiting the efficiency of the program. One the other hand, it is possible to dramatically reduce the number of trainable parameters by predefining the shape of the approximation function. For example, by looking at the dataset plotted in FIG. 21, we can assume that the dataset follows a piecewise linear trend that consists of two linear regression lines. For the same dataset, an FFNN regression with 3 hidden layers and 10 neurons for each layer and a piecewise linear regression are conducted. As shown in FIG. 21, the mean squared error of the trained regressions are similar to each other, but the number of trainable parameters are 281 for the FFNN and only 6 for the piecewise linear regression, resulting in a huge reduction in the training time (computational cost) of the piecewise linear regression.

This example implies that one can dramatically improve the efficiency of a neural network by assuming the functional form of the neural network, which became the foundation of the C-HiDeNN theory.

### C-HiDeNN Theory and Algorithm

C-HiDeNN theory and algorithm is based on the Hierarchical Deep-learning Neural Network (HiDeNN)-FEM, that replaces the entire FEM process with partially connected hierarchical DNNs. HiDeNN-FEM shape functions replace the weights and biases with the nodal coordinates and the nodal field variables such that they are mathematically equivalent to FEM shape functions. Then the elementwise HiDeNN-FEM shape functions coalesce to form a global loss function based on the principle of minimum potential energy. Now the problem has changed from classical FEM to an optimization problem, which is the core concept of Engineering Software 2.0. Since both the nodal coordinates and the nodal field variables compose the HiDeNN-FEM shape functions, the present invention solves for nodal field variables while updating nodal coordinates, x, (analogous to the r-mesh adaptivity) at the same time.

C-HiDeNN is the seamless integration of HiDeNN-FEM shape functions with convolution patch functions to expand the linear interpolation space to nonlinear or arbitrary functions. In terms of the functional space, C-HiDeNN encompasses HiDeNN-FEM because of these convolution patch functions. C-HiDeNN shape functions are built on the partition of unity (POU) concept, using the linear finite element family but can be designed to have higher smoothness and arbitrary “p” order of convergence rates; no need to exploit higher order elements. The resulting features of C-HiDeNN are orders of magnitude more accurate solutions, faster convergence rates, and the removal of locking with the linear finite element meshes. The convolution patch functions are constructed by interpolating “s”-layer of neighboring elements called patch domain. These patch functions are controlled by patch size “s”, dilation parameter “a”, and reproducing order “p”, which is analogous to adding/deleting extra hidden layers or neurons to a neural network. They behave like convolution filters that are used in signal processing, applied mathematics, convolutional neural networks, and the reproducing kernel particle method (RKPM).

Global DOFs of C-HiDeNN are the same as the linear FEM as they are still using linear elements, but the C-HiDeNN global stiffness matrix has a larger bandwidth than that of the linear FEM. For this reason, the iterative solver time of C-HiDeNN is longer than the FEM with the same degrees of freedom, but the slowdown is compensated by drastic improvements in accuracy and “p”-order convergence rates. The major computational overhead of C-HiDeNN comes from the addition of the convolution patch functions. In one embodiment, the present invention parallelizes this computation with graphics processing units (GPUs) programming algorithm.

### Hierarchical Deep-Learning Neural Networks (HiDeNN)-FEM

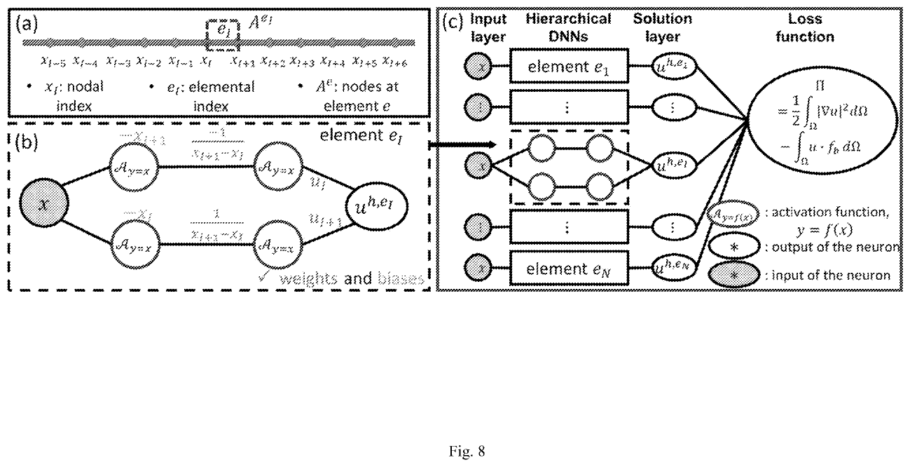

FIG. 8 shows HiDeNN-FEM formulation for a 1-D Poisson's problem. Light blue and orange terms are weights and biases of the neural network, respectively. If there is no weight or bias assigned for a neuron, it will have fixed weight=1 and bias=0. Functions inside neurons with blue edges represent activation functions while those with black edges represent the inputs (green color) and outputs (white color) of the neuron. Panel (a) shows nodal coordinates in physical space with an element of interest e₁. Panel (b) represents HiDeNN-FEM shape function of the element e₁. This small neural network constitutes the hierarchical DNN layer of the global neural network Panel (c).

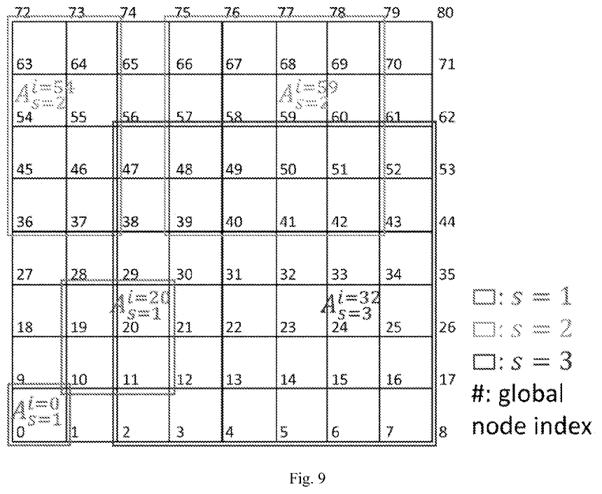

HiDeNN-FEM is a custom-designed neural network such that the mathematical form of the neural network can be equivalent to POU-FEM or POU-meshfree methods, and many others. As can be seen in FIG. 8 panel (b), the elementwise shape function is expressed with two hidden layers and two hidden neurons on each layer. This is written as

$${u}^{h , {e}_{I}} ( x ) = {A}_{y = x} ( - \frac{1}{{x}_{I + 1} - {x}_{I}} {A}_{y = x} ( x - {x}_{I + 1} ) ) {u}_{I} + {A}_{y = x} ( \frac{1}{{x}_{I + 1} - {x}_{I}} {A}_{y = x} ( x - {x}_{I} ) ) {u}_{I + 1} \qquad ( 1 )$$

where u^{h,e}^{_{I}}(x) is the approximated field variable at element e_{I}, u_{I} is the nodal field value, and [symbol] y=ƒ(x) represents an activation function of y=ƒ(x). For example, [symbol] y=x and [symbol] y=max(x,0) represent the identity and Rectified Linear Unit (ReLU) activation functions, respectively. Thus, the activation functions are non-trainable once they are defined. Note that the hidden layers are partially connected, and the corresponding weights and biases are constrained to be functions of nodal coordinates and nodal field variables. HiDeNN-FEM can also be constructed for “p” finite elements such as higher order polynomial, B-spline, and reproducing kernel approximation. FIG. 9 illustrates the nodal patch domain

$$( {A}_{s}^{i} )$$

on a 2-D, 8×8 element mesh. s is the patch size and the domains are colored by the patch size.

### Convolution Patch Functions

Convolution patch functions interpolate the nodal patch domain

$${A}_{s}^{i}$$

(integer) and i is the center node.

$${A}_{s}^{i}$$

refers to a domain centered at node i and s layers of elements surrounding node i. Suppose that one has an 8×8 uniform element depicted in FIG. 9. By definition,

$${A}_{s = 1}^{i = 20}$$

refers to one layer of nodes surrounding node 20: nodes 10, 11, 12, 19, 20, 21, 28, 29, 30. The same applies to the other domains. Note that nodes near the domain boundary might have patch domains that are different in size and shape compared with those far from the boundary. For example,

$${A}_{s = 1}^{i = 0}$$

consists of four nodes as the center node 0 is at the corner of the global domain. Similarly,

$${A}_{s = 2}^{i = 54}$$

has only 15 nodes because the center node 54 is at the domain boundary. Although FIG. 9 only describes a uniform 2-D mesh, the same rule works for non-uniform 3-D meshes. In one embodiment, nodal coordinates of a patch domain

$${A}_{s}^{i}$$

are denoted as

$${x}^{{A}_{s}^{i}} .$$

One way of constructing convolution patch functions is by borrowing well-established meshfree techniques. One can use the reproducing kernel element method (RKEM), hierarchical enrichment, radial point interpolation method, reproducing kernel peridynamics, etc. In one embodiment, the present invention borrows the idea of the radial point interpolation method (RPIM) as it achieves stable interpolants possessing a Kronecker delta property. Although the RPIM theory is grounded in the meshfree method, one will call this interpolation function as the convolution patch function in the rest of this work for consistency of notation and generality.

In the present invention, the RPIM theory is reviewed. A field variable u(x) inside a nodal patch domain

$${A}_{s}^{i}$$

can be interpolated with radial basis Rⱼ (x) and polynomial basis pₖ (x) functions as

$$\begin{matrix}u ( x ) = {\sum }_{j = 1}^{n} {R}_{j} ( x ) {b}_{j} + {\sum }_{k = 1}^{m} {p}_{k} ( x ) {c}_{k} \\ = {R}^{T} ( x ) b + {p}^{T} ( x ) c = \begin{matrix}[ {R}^{T} ( x ) & {p}^{T} ( x ) ]\end{matrix} \{ \begin{matrix}b \\ c\end{matrix} \}\end{matrix} \qquad ( 2 )$$

where n is the number of nodes in a domain

$${A}_{s}^{i}$$

and m is the number of complete polynomial basis functions, which is determined by the reproducing polynomial order p and the dimension of the problem. For example, in a 2-D problem, second order reproducing condition (p=2) requires m=6 polynomial basis functions: 1, x, y, x², xy, y². b and c are the coefficients to be determined by imposing the Kronecker delta function property.

A radial basis function Rⱼ(x) is a function of only the radial distance between x and xⱼ(=rⱼ(x)). For 2-D problems with Euclidean norm, Rⱼ(x) is a function of

$${r}_{j} ( x ) = \sqrt{{( x - {x}_{j} )}^{2} + {( y - {y}_{j} )}^{2}} \qquad ( 3 )$$

where (xⱼ, yⱼ) is the coordinate of node j. One can use compactly supported radial basis functions listed in Table 1 where one chooses the cubic spline function for our program. In these functions, the dimension of local support is determined by the dilation parameter a. If

$$\frac{{r}_{j}}{a} > 1 ,$$

the radial basis functions return zero.

TABLE 1
Typical compactly supported radial basis functions.

| Function | Formulation | Reference |
|---|---|---|
| Cubic spline | ${R}_{j} ( {r}_{j} ; a ) = \{ \begin{matrix}\frac{2}{3} − 4 \frac{{r}_{j}^{2}}{{a}^{2}} + 4 \frac{{r}_{j}^{3}}{{a}^{3}} & for 0 \leq \frac{{r}_{j}}{a} \leq \frac{1}{2} \\ \frac{4}{3} − 4 \frac{{r}_{j}}{a} + 4 \frac{{r}_{j}^{2}}{{a}^{2}} − \frac{4}{3} \frac{{r}_{j}^{3}}{{a}^{3}} & for \frac{1}{2} \leq \frac{{r}_{j}}{a} \leq 1 \\ 0 & otherwise\end{matrix}$ | Liu (1995) |
| Wu-C2 | ${R}_{j} ( {r}_{j} ; a ) = \{ \begin{matrix}{( 1 − \frac{{r}_{j}}{a} )}^{5} ( 8 + 40 \frac{{r}_{j}}{a} + 48 \frac{{r}_{j}^{2}}{{a}^{2}} + 25 \frac{{r}_{j}^{3}}{{a}^{3}} + 5 \frac{{r}_{j}^{4}}{{a}^{4}} ) & for 0 \leq \frac{{r}_{j}}{a} \leq 1 \\ 0 & otherwise\end{matrix}$ | Wu (1995) |
| Wendland-C2 | ${R}_{j} ( {r}_{j} ; a ) = \{ \begin{matrix}{( 1 − \frac{{r}_{j}}{a} )}^{4} ( 1 + 4 \frac{{r}_{j}}{a} ) & for 0 \leq \frac{{r}_{j}}{a} \leq 1 \\ 0 & otherwise\end{matrix}$ | Wendland (1995) |

The coefficients bⱼ and cₖ are determined by imposing the Kronecker delta function property, which can be written as

$${u}_{n} = {R}_{n} b + {P}_{m} c \qquad ( 4 )$$

where the vector for the nodal field variable is

$${u}_{n} = {\{ {u}_{1} , {u}_{2} , … {u}_{n} \}}^{T} , \qquad ( 5 )$$

the moment matrix of the radial basis function is

$${R}_{n} = {[ \begin{matrix}{R}_{1} ( {r}_{1} ) & {R}_{2} ( {r}_{1} ) & … & {R}_{n} ( {r}_{1} ) \\ {R}_{1} ( {r}_{2} ) & {R}_{2} ( {r}_{2} ) & … & {R}_{n} ( {r}_{2} ) \\ ⋮ & ⋮ & ⋱ & ⋮ \\ {R}_{1} ( {r}_{n} ) & {R}_{2} ( {r}_{n} ) & … & {R}_{n} ( {r}_{n} )\end{matrix} ]}_{( n \times n )} , \qquad ( 6 )$$

the moment matrix of the polynomial basis function is

$${P}_{m} = {[ \begin{matrix}1 & {x}_{1} & {y}_{1} & … & {p}_{m} ( {x}_{1} ) \\ 1 & {x}_{2} & {y}_{2} & … & {p}_{m} ( {x}_{2} ) \\ ⋮ & ⋮ & ⋮ & ⋱ & ⋮ \\ 1 & {x}_{n} & {y}_{n} & … & {p}_{m} ( {x}_{n} )\end{matrix} ]}_{( n \times m )} , \qquad ( 7 )$$

and the coefficients b and c are

$$b = {\{ \begin{matrix}{b}_{1} & {b}_{2} & … & {b}_{n}\end{matrix} \}}^{T} \qquad ( 8 )$$

$$c = {\{ \begin{matrix}{c}_{1} & {c}_{2} & … & {c}_{m}\end{matrix} \}}^{T} .$$

As seen in Eq. (8), one has total (n+m) unknowns but there are only n equations in Eq. (4). Therefore, one needs extra m equations to fully determine the coefficients. The following additional m constraints are usually used to resolve the ambiguity:

$${P}_{m}^{T} b = 0 . \qquad ( 9 )$$

Finally, one gets the system of (n+m) linear equations:

$$\{ \begin{matrix}{u}_{n} \\ 0\end{matrix} \} = [ \begin{matrix}{R}_{n} & {P}_{m} \\ {P}_{m}^{T} & 0\end{matrix} ] \{ \begin{matrix}b \\ c\end{matrix} \} = G \{ \begin{matrix}b \\ c\end{matrix} \} . \qquad ( 10 )$$

Note that the assembled moment matrix G is symmetric because the radial basis moment matrix Rₙ is also symmetric and the additional m constraints are set as the transpose of Pₘ (see Eq. (9)). If G is a full-rank matrix, the coefficients b and c are uniquely determined as

$$\{ \begin{matrix}b \\ c\end{matrix} \} = {G}^{- 1} \{ \begin{matrix}{u}_{n} \\ 0\end{matrix} \} . \qquad ( 11 )$$

By substituting Eq. (2) with Eq. (11), one gets

$$u ( x ) = \begin{matrix}[ {R}^{T} ( x ) & {p}^{T} ( x ) ]\end{matrix} {G}^{- 1} \{ \begin{matrix}{u}_{n} \\ 0\end{matrix} \} \qquad ( 12 )$$

$$= \tilde{W} ( x ) \{ \begin{matrix}{u}_{n} \\ 0\end{matrix} \} .$$

In one embodiment, \tilde{W}(x) is a (n+m)-component row vector and the last m components are ignored because they are multiplied by zeros. If one denotes the first n components of \tilde{W}(x) by \tilde{W}(x), which one refers to as convolution patch functions, one finally can interpolate the field variable using radial basis functions with reproducing polynomial order p and the Kronecker delta property:

$$u ( x ) = W ( x ) {u}_{n} \qquad ( 13 )$$

Likewise, the derivative of the convolution patch function can be obtained by replacing the basis functions with their derivatives:

$$\begin{matrix}\frac{\partial u ( x )}{\partial x} = [ \frac{\partial {R}^{T} ( x )}{\partial x} \frac{\partial {p}^{T} ( x )}{\partial x} ] {G}^{- 1} \{ \begin{matrix}{u}_{n} \\ 0\end{matrix} \} \\ = \frac{\partial \tilde{W} ( x )}{\partial x} \{ \begin{matrix}{u}_{n} \\ 0\end{matrix} \} .\end{matrix} \qquad ( 14 )$$

Since one can arbitrarily choose reproducing order p, C-HiDeNN can achieve arbitrary convergence rates, resulting in superior accuracy compared to linear FEM. In addition, due to the Kronecker delta function property, one does not need special treatment for boundary conditions.

### Graph Theory for Computing Nodal Connectivity

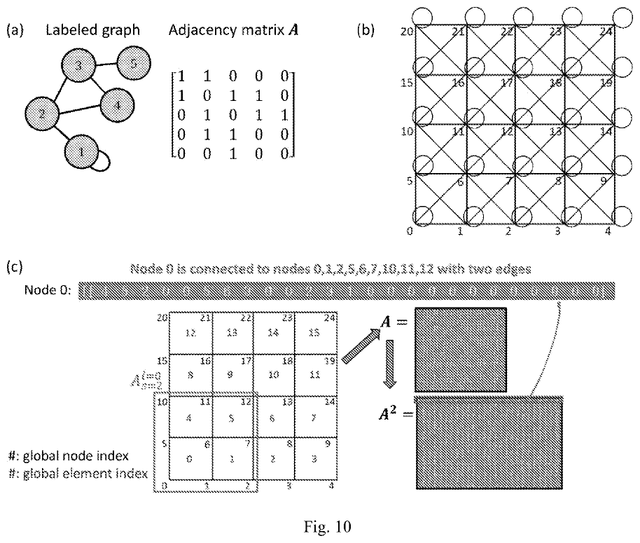

FIG. 10 shows in panel (a) A basic illustration of graph theory; panel (b) A graph for 4×4 uniform element. For each element, all pairs of nodes are connected, including self-connection; and panel (c) shows how the graph theory is used to find nodal patch domain

$${A}_{s}^{i} .$$

The nodal patch domain

$${A}_{s}^{i}$$

is a domain centered at node i and encompasses s layers of elements surrounding node i. This definition naturally embodies the concept of nodal (or elemental) connectivity, for which, in one embodiment, the present invention borrows ideas from graph theory. In this section, one reviews the basic graph theory and demonstrate how it finds patch domains efficiently.

Graphs in graph theory refer to mathematical structures that display pairwise connectivity relationships between nodes. FIG. 10 panel (a) shows a labeled graph of five nodes (aka vertices) and their connectivity relationships displayed with edges. For example, node two is connected to nodes 1, 3, and 4, while node 1 is connected to node 1 (itself) and 2. The graph is mathematically represented with a binary 5×5 matrix, called the adjacency matrix A, whose components are defined as:

$${A}_{i j} = \{ \begin{matrix}1 , & if node i and node j are connected \\ 0 , & if node i and node j are not connected\end{matrix} \qquad ( 15 )$$

In graph theory, the s^{th} power of the adjacency matrix A^{S} represents s^{th} order connectivity. That is,

$${A}_{i j}^{s}$$

is the number of different ways to move from node i to node j that pass through s edges (i.e., in s steps).

In FIG. 10 panel (b), one generates an adjacency matrix based on a 4×4 elements (or 5×5 nodes) uniform mesh. It is assumed that all nodes in an element are connected, and each node has a self-connection. For example, node 0 is connected to node 0 (itself), 1, 5, and 6. Node 1 is connected to nodes 0, 1 (itself), 2, 5, 6, and 7. The generated adjacency matrix is a 25×25 sparse, binary, square, and symmetric matrix.

By definition, A² tells us the second-order connectivity. The red dashed box in FIG. 10 panel (c) shows the first row of A² where one can see components 0, 1, 2, 5, 6, 7, 10, 11, and 12 are non-zero. This means that these nodes are connected to node 0 with two edges, and the value of each component tells the number of different combinations of two edges. The nodal patch domain at node i=0 with patch size s=2 is therefore

$${A}_{s = 2}^{i = 0} = \{ 0 , 1 , 2 , 5 , 6 , 7 , 10 , 11 , 12 \} . \qquad ( 16 )$$

Likewise, one can readily get other patch domains from the same matrix A².

$$\begin{matrix}{A}_{s = 2}^{i = 6} = \{ 0 , 1 , 2 , 3 , 5 , 6 , 7 , 8 , 10 , 11 , 12 , 13 , 15 , 16 , 17 , 18 \} \\ {A}_{s = 2}^{i = 12} = \{ 0 , 1 , 2 , 3 , 4 , 5 , 6 , 7 , 8 , 9 , 10 , 11 , 12 , 13 , 14 , 15 , 16 , 17 , 18 , 19 , 20 , 21 , 22 , 23 , 24 \} \\ … \\ {A}_{s = 2}^{i} = \{ j \vert j is a non - zero column index of {i}^{th} row of {A}^{2} \}\end{matrix} \qquad ( 17 )$$

One important reason for using graph theory is that the adjacency matrix is a sparse binary matrix. Thus, one can use sparse matrix libraries for matrix multiplication that can save a huge amount of memory and computation time. In our current code, one use SciPy1 at scipy.org sparse matrix libraries in Python to compute nodal patch domains with no need for parallelization, as it is fast enough with the serial SciPy algorithm (for one million nodes, A² and A⁴ took 4 and 6 seconds, respectively).

### C-HiDeNN Formulation for 1-D Poisson's Problem

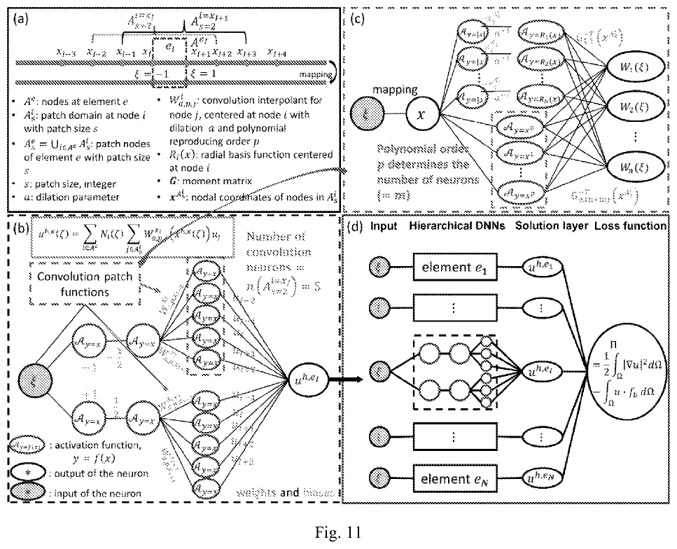

FIG. 11 shows C-HiDeNN formulation for a 1-D Poisson's problem. Light blue and orange terms are weights and biases of the neural network, respectively. If there is no weight or bias assigned for a neuron, it will have fixed weight=1 and bias=0. Functions inside neurons with blue edges represent activation functions while those with black edges represent the input (green color) and output (white color) of the neuron. Panel (a) shows nodal coordinates in both physical and parametric space, focusing on the element of interest e_I. Nodal patch domains and other terminologies are defined below. Panel (b) represents the C-HiDeNN shape function of the element e_I, which constitutes the hierarchical DNN layer of the global neural network (d). Panel (c) is the convolution patch function that can be found in the brown dashed box in panel (b).

This section demonstrates how, in one embodiment, the present invention formulates C-HiDeNN. For simplicity, one starts with a 1-D Poisson's equation but later expand to 2-D and 3-D problems. The interpolated field variable in element e in the parametric domain (u^{h,e}(ξ)) is given as:

$${u}^{h , e} ( ξ ) = {\sum }_{i ∈ {A}^{e}} {N}_{i} ( ξ ) {\sum }_{j ∈ {A}_{s}^{i}} {W}_{a , p , j}^{{x}_{i}} ( {x}^{h , e} ( ξ ) ) {u}_{j} = {\sum }_{k ∈ {A}_{s}^{e}} {\tilde{N}}_{k} ( ξ ) {u}_{k} , \qquad ( 18 )$$

with elementwise mapping from the parametric domain to the physical domain for element e:

$${x}^{h , e} ( ξ ) = {\sum }_{i ∈ {A}^{e}} {N}_{i} ( ξ ) {x}_{i} \qquad ( 19 )$$

where Nᵢ(ξ) is a general polynomial interpolant (for simplicity, one can view this as linear FEM shape functions) at node i and

$${W}_{a , p , j}^{{x}_{i}} ( {x}^{h , e} ( ξ ) )$$

is the convolution patch function at node j defined on the support domain

$${A}_{s}^{i} .$$

It is important to note that the convolution patch function is defined in the physical domain with x-coordinates because it is more straightforward to implement the RPIM theory. If one wants to define the convolution patch function in the parametric domain with ξ-coordinates, an inverse mapping from the physical domain to the parametric domain is required, which is mathematically nonobvious. Therefore, one first maps from ξ-coordinates to x-coordinates using Eq. (19), then compute convolution patch function in the physical domain.

Finally, the double summation is rearranged to a single summation over elemental patch nodes

$${A}_{s}^{e} = {⋃}_{i ∈ {A}^{e}} {A}_{s}^{i}$$

In one embodiment, one highlights the definition of elemental patch nodes

$${A}_{s}^{e} .$$

The element e_{I} in FIG. 11 panel (a) has two nodal patch domains,

$${A}_{s = 2}^{i = {x}_{I}} = \{ {x}_{I - 2} , … {x}_{I + 2} \} and {A}_{s = 2}^{i = {x}_{I + 1}} = \{ {x}_{I - 1} , … {x}_{I + 3} \}$$

when s=2. As the elemental patch domain is the union of nodal patch domains,

$${A}_{s = 2}^{e = {e}_{i}} = \{ {x}_{I - 2} , … {x}_{I + 3} \} .$$

Now the interpolated field variable u^{h,e}(ξ) is expressed as a summation of the convolutional interpolant Ñₖ(ξ) times nodal variable uₖ over the elemental patch nodes

$${A}_{s}^{e}$$

(Eq. (18)). Definitions of the notation can also be found in FIG. 11 panel (a).

The general polynomial interpolant Nᵢ(ξ) satisfies compact support and partition of unity, while the convolution patch function

$${W}_{a , p , j}^{{x}_{i}} ( ξ )$$

additionally satisfies the Kronecker delta and reproducing conditions. These conditions are given:

$$\begin{matrix}\begin{matrix}Compact support for \\ general polynomial interpolants\end{matrix} & {A}^{e} ⊂\end{matrix} {⋃}_{i ∈ {A}^{e}} {A}_{s}^{i} \qquad ( 20 )$$

$$\begin{matrix}Partition of unity for \\ general polynomial interpolants\end{matrix} \qquad {\sum }_{i ∈ {A}^{e}} {N}_{i} ( ξ ) = 1$$

$$\begin{matrix}\begin{matrix}Kronecker delta for \\ convolution patch functions\end{matrix} & {W}_{a , p , j}^{{x}_{i}} ( x ) {\vert}_{x = {x}_{l}}\end{matrix} = {δ}_{jl} , where j , l ∈ {A}_{s}^{i}$$

$$\begin{matrix}Reproducing condition for \\ convolution patch functions\end{matrix} \qquad {\sum }_{j ∈ {A}_{s}^{i}} {W}_{a , p , j}^{{x}_{i}} ( x ) p ( {x}_{j} ) = p ( x )$$

The resulting convolution interpolant Ñₖ(ξ) satisfies the partition of unity, Kronecker delta, and reproducing conditions, thus the application of both Dirichlet and Neumann boundary conditions is straightforward.

The neural network formulation of C-HiDeNN is visualized in FIG. 11 such that it follows a similar format to HiDeNN-FEM in FIG. 8. FIG. 11 panel (a) illustrates how the nodal patch domains

$${A}_{s}^{i}$$

are constructed based on the patch size s. FIG. 11 panel (b) shows an elemental shape function like the one in FIG. 8 panel (b). The first two hidden layers with two hidden neurons are the same as HiDeNN-FEM. However, C-HiDeNN has one more hidden layer with a greater number of neurons that represent enhanced connectivity between neighboring nodes. Note that the number of neurons on the third hidden layer is determined by the number of elements of the nodal patch domain,

$$n ( {A}_{s}^{i} )$$

the purple dashed box in FIG. 11 panel (b)). Like Eq. (1), one can write this elemental neural network as:

$${u}^{h , {e}_{I}} ( ξ ) = {\sum }_{j ∈ {A}_{s}^{I}} [ {u}_{j} {𝒜}_{y = x} ( {W}_{a , p , j}^{{x}_{I}} ( ξ ) {𝒜}_{y = x} ( - \frac{1}{2} {𝒜}_{y = x} ( ξ - 1 ) ) ) ] + {\sum }_{j ∈ {A}_{s}^{I + 1}} [ {u}_{j} {𝒜}_{y = x} ( {W}_{a , p , j}^{{x}_{I + 1}} ( ξ ) {𝒜}_{y = x} ( \frac{1}{2} {𝒜}_{y = x} ( ξ + 1 ) ) ) ] . \qquad ( 21 )$$

The weights of the third hidden layer are the convolution patch functions constructed by a sub-neural network in FIG. 11 panel (c). This follows the derivation of RPIM. One can also write this sub-neural network as:

$${W}_{j} ( ξ ) = {\sum }_{l = 1}^{n} [ {G}_{j , l}^{- T} {𝒜}_{y = {R}_{l} ( x )} ( \frac{1}{a} {𝒜}_{y = \vert x \vert} ( x ( ξ ) - {x}_{l}^{{A}_{s}^{i}} ) ) ] + {\sum }_{k = 1}^{m} [ {G}_{j , n + k}^{- T} {𝒜}_{y = {x}^{k - 1}} ( x ( ξ ) ) ] \qquad ( 22 )$$

$$j = 1 , 2 , … , n$$

where the mapping from the parametric domain to the physical domain is

$$x ( ξ ) = {\sum }_{i ∈ {A}^{e}} {N}_{i} ( ξ ) {x}_{i} , \qquad ( 23 )$$

n is the number of nodes in a patch domain

$${A}_{s}^{I} ,$$

and the assembled moment matrix G is taken from Eq. (10). The

$${G}_{j , l}^{- T}$$

is (j, l) component of the inverse transpose of G. It is important to note that the reproducing polynomial order p determines the number of neurons inside the red dashed box (=m) in FIG. 11 panel (c). In 1-D, there are m=p+1 neurons, each of which represents polynomial basis from x⁰ to x^{p}.

The first hidden layer in FIG. 11 panel (c) normalizes the radial distance by passing it through the absolute activation function [symbol] y=|x| and dividing it with the dilation parameter a. Then the normalized distance enters the second hidden layer with the radial basis activation function. In one embodiment, the dilation parameter a extracts multiresolution features of a patch domain by acting as a normalization parameter of radial distances and turning off neurons in the second hidden layer whose normalized radial distance is farther than a. The first and second hidden layers correspond to the radial and polynomial basis functions [R^{T}(x) p^{T}(x)] in Eq. (12). Between the second hidden layer and the output layer, the inverse of the assembled moment matrix G⁻¹ is multiplied component-wise. This operation corresponds to [R^{T}(x) p^{T}(x)]G⁻¹ in Eq. (12). Thus, the output layer of FIG. 11 panel (c) yields convolution patch functions W(x).

Finally, the elementwise neural network in FIG. 11 panel (b) and Eq. (22) is integrated with the sub-neural network for the convolution patch functions in FIG. 11 panel (c) and Eq. (23), yielding:

$${u}^{h , {e}_{I}} ( ξ ) = {\sum }_{j ∈ {A}_{s}^{I}} [ {u}_{j} {𝒜}_{y = x} ( \{ {\sum }_{l ∈ {A}_{S}^{I}} [ {G}_{j , l}^{- T} {𝒜}_{y = {R}_{l} ( x )} ( \frac{1}{a} {𝒜}_{y = \vert x \vert} ( x ( ξ ) - {x}_{l}^{{A}_{s}^{i}} ) ) ] + {\sum }_{k = 1}^{m} [ \text{} {G}_{j , n + k}^{- T} \text{} {𝒜}_{y = {x}^{k - 1}} ( x ( ξ ) ) ] \} {𝒜}_{y = x} ( - \frac{1}{2} {𝒜}_{y = x} ( ξ - 1 ) ) ) ] + {\sum }_{j ∈ {A}_{s}^{l + 1}} [ {u}_{j} {𝒜}_{y = x} ( \{ {\sum }_{l ∈ {A}_{s}^{l + 1}} [ {G}_{j , l}^{- T} {𝒜}_{y = {R}_{l} ( x )} ( \frac{1}{a} {𝒜}_{y = \vert x \vert} ( x ( ξ ) - {x}_{l}^{{A}_{s}^{i}} ) ) ] + {\sum }_{k = 1}^{m} [ {G}_{j , n + k}^{- T} {𝒜}_{y = {x}^{k - 1}} ( x ( ξ ) ) ] \} {𝒜}_{y = x} ( \frac{1}{2} {𝒜}_{y = x} ( ξ + 1 ) ) ) ] . \qquad ( 24 )$$

Eq. (24) is a neural network representation of elemental C-HiDeNN interpolants in 1-D that corresponds to Eq. (18). Like HiDeNN-FEM in FIG. 8, these elementwise neural networks compose the global neural network in FIG. 11 panel (d).

One can see the “hierarchy” among the neural networks: the global neural network in FIG. 11 panel (d), the elemental neural network in FIG. 11 panel (b), and the sub-neural network for convolution patch functions in FIG. 11 panel (c). One can then formulate optimization problems as below:
Solve (find nodal solutions):

$$U = arg {min}_{{u}_{i} ∈ {ℝ}^{d}} \prod ( {u}^{C - HiDeNN} ( x ; U , X , a , s , p ) )$$

Train (find optimal parameters):

$$X , a , s , p = {arg min}_{{x}_{i} ∈ Ω \backslash \partial Ω , a ∈ {ℝ}^{+} , s ∈ ℕ , p ∈ ℕ} \prod ( {u}^{C - HiDeNN} ( x ; U , X , a , s , p ) )$$

where X is the nodal coordinates, U is the nodal variables, and s, a, and p are the convolutional interpolation parameters described above. Π is the loss function to be minimized formulated for the given computational science and engineering (CS&E) problem, which in this case, is the Poisson's equation. The first optimization solves for the nodal variables, given the nodal coordinates and the three parameters, s, a, and p. This is similar to the classical numerical methods. The second optimization trains the parameters, X, a, s, p, given the nodal solution U. The parameters s, a, p can be locally or globally optimized, rendering further improvements on the efficiency. This process is similar to the mesh adaptivity in classical FEA, but C-HiDeNN realizes versatile adaptable parameters with a more systematical approach by leveraging hierarchical neural networks. In summary, C-HiDeNN can both solve and train for a given partial differential equation (PDF) that is much more accurate and faster than classical numerical methods.

### C-HiDeNN Formulation for 2-D and 3-D Problems

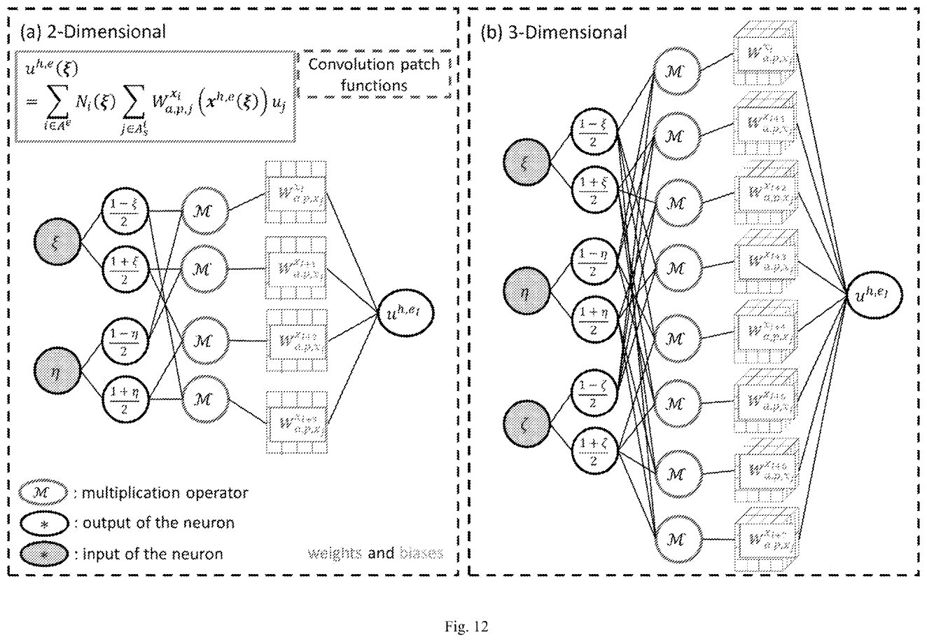

The C-HiDeNN structure can readily be expanded to n-dimensional problems by employing n-dimensional kernels as convolution patch functions. FIG. 12 illustrates C-HiDeNN shape functions for 2-D 4-node element (a) and 3-D 8-node element (b) each of which corresponds to FIG. 11 panel (b), the black dashed box. The first hidden layer outputs unidirectional shape functions followed by the multiplication building blocks (red-edged neurons) in the second hidden layer, but in short, it is a neuron that performs multiplication operations). Thus, the output of the second hidden layer is the nodal finite element shape function in the parametric domain. Then the third hidden layer is responsible for the convolution operation with 2-D (a) or 3-D (b) kernels whose values are from the convolution patch functions. Like the 1-D example in FIG. 11 panel (b), the patch size s determines the size of the kernel while the kernel values are computed in the same way described in FIG. 11 panel (c).

FIG. 12 shows C-HiDeNN shape function of element er for 2-D 4-node (a) and 3-D 8-node (b) elements. Each figure is a replacement for FIG. 11 panel (b). A red-edged neuron with M symbol denotes a multiplication operator (i.e., multiply all inputs).

Conditions for Parameters “s”, “a”, and “p”

There are three controlling parameters in C-HiDeNN interpolation: s, a, p, which can be optimized to enhance solution efficiency for a specific problem. Table 2 summarizes conditions for those parameters. The patch size s is a positive integer and should be greater than or equal to

$$\frac{p}{2} . If s = \frac{p}{2} ,$$

the convolution patch function becomes the Lagrange polynomial regardless of the choice of radial basis functions. The dilation parameter a should be a positive real number [symbol] ⁺. The reproducing polynomial order p should be a positive integer.

TABLE 2
Conditions for parameters “s”, “a”, and “p”

| Parameters | s | a | p |
|---|---|---|---|
| Conditions | $s \geq \frac{p}{2} , s ∈ {ℕ}^{+}$ | a ∈ [symbol] ⁺ | p ∈ [symbol] ⁺ |

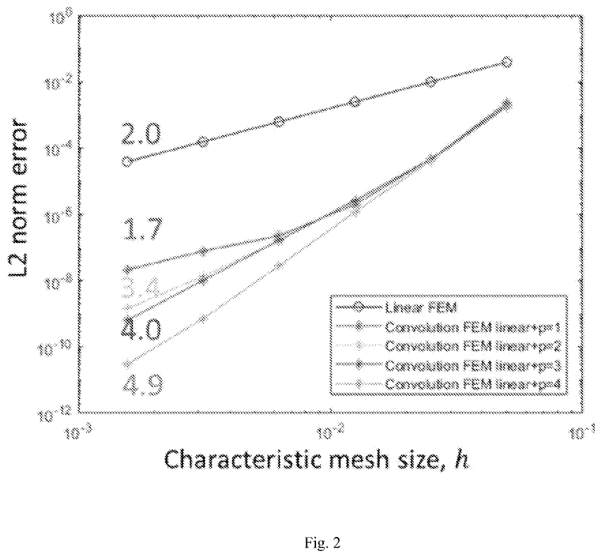

C-HiDeNN forward analysis method can achieve faster convergence rates depending on the reproducing order, p. FIG. 2 shows the convergence plot of L2 norm error where the 1D Poisson's problem is solved. The numbers inside the plot denote convergence rates. Theoretically, the convergence rate of linear FEM is 2.0 for L2 norm error. However, C-HiDeNN (or C-FEM) can achieve higher convergence rates depending on the reproducing order, p. The order p can be elevated by increasing the patch size s without increasing the degrees of freedom.

### C-HiDeNN-Tensor Decomposition (TD)

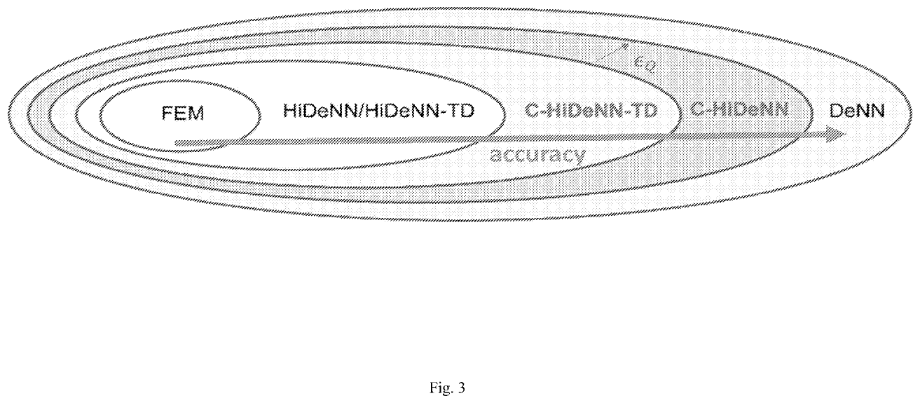

To further improve computational efficiency, the C-HiDeNN interpolant will be integrated with the Tensor Decomposition (TD) reduced order modeling approximation. The idea of TD is based on the separation of variables and can overcome the exponential growth of the computational costs of traditional numerical methods (such as FEM) as the dimensionality of the parametric space grows (the curse of the dimension). Therefore, TD can solve extra-large scale problems with orders of magnitude speedups compared to FEM. Theoretically, the C-HiDeNN method should have a larger function approximation space than HiDeNN as the convolution operation introduces built-in filters for improved smoothness. Hence, its reduced order version C-HiDeNN-TD is also expected to have a relatively large functional space, as shown in FIG. 3.

C-HiDeNN-TD approximation for a 3D problem is written as

$${u}^{C - HiDeNN - TD} ( ξ ) = {u}^{C - HiDeNN - TD} ( ξ , η , γ ) = {\sum }_{m = 1}^{M} {\tilde{N}}_{ξ} {u}_{ξ}^{( m )} {\tilde{N}}_{η} {u}_{η}^{( m )} {\tilde{N}}_{γ} {u}_{γ}^{( m )} . \qquad ( 25 )$$

$$where {\tilde{N}}_{ξ} = [ {\tilde{N}}_{1} ( ξ ) , {\tilde{N}}_{2} ( ξ ) , … , {\tilde{N}}_{{n}_{ξ}} ( ξ ) ]$$

is the 1D convolution shape function written in vector form,

$${u}_{ξ}^{( m )} = {[ {u}_{1}^{( m )} , {u}_{2}^{( m )} , … , {u}_{{n}_{ξ}}^{( m )} ]}^{T}$$

is the nodal solution vector for the m-th mode in the ξ-direction, assuming the total number of modes is M and is small enough compared to the system size. This definition is similar for other directions. It can be seen that the separation of variables allows adopting only 1D convolution shape function and solving 1D nodal solutions for a multidimensional problem. This advantage enables a high computational complexity reduction. In particular, the total number of degrees of freedom (DoFs) of the system is reduced from nₓ×n_{y}×n_{z} to (nₓ+n_{y}+n_{z})×M, assuming nₓ, n_{y}, n_{z} are respectively the number of nodes in the three directions (x, y, z) of a 3D field. This reduction leads to the so-called reduced order model.

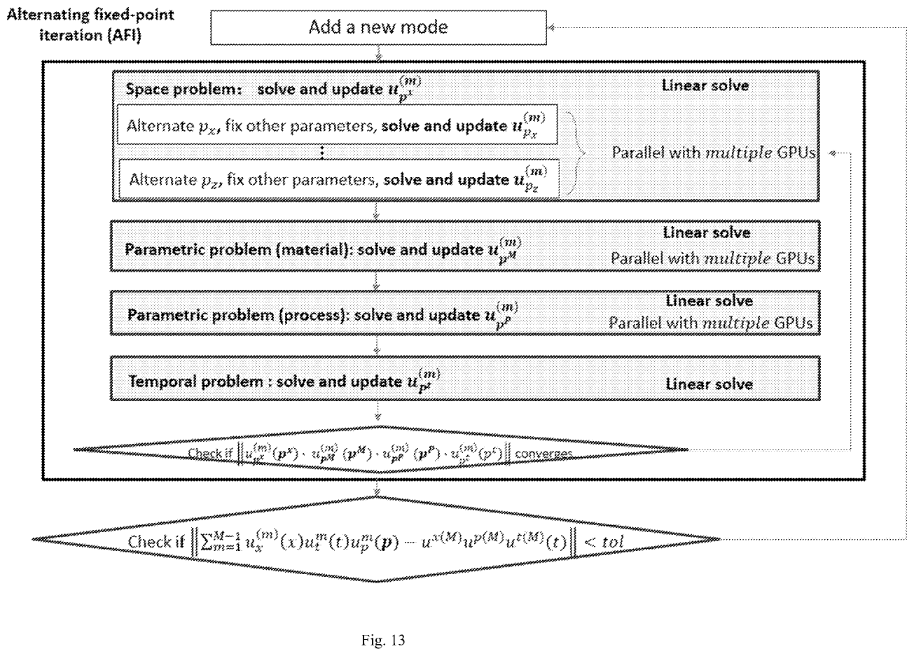

The solution procedure of C-HiDeNN-TD is described below. The C-HiDeNN-TD solution can be solved through two different methods: 1) alternating fixed-point algorithm (AFI) and 2) minimization problem. The alternate fixed-point algorithm for a general 3-D spatial, parametric, and temporal problem is illustrated in FIG. 13. In this general problem, we have 3 spatial variables, uₚ_{ₓ}, uₚ_{_{y}}, uₚ_{_{z}}, one material variable, uₚ_{^{M}}, one process variable, uₚ_{^{p}}, and one temporal variable, uₚ_{^{t}}; a total of 6 variables. In AFI, we only vary one variable at once while fixing other variables. For example, at m-th mode, we solve for

$${u}_{{p}^{x}}^{( m )}$$

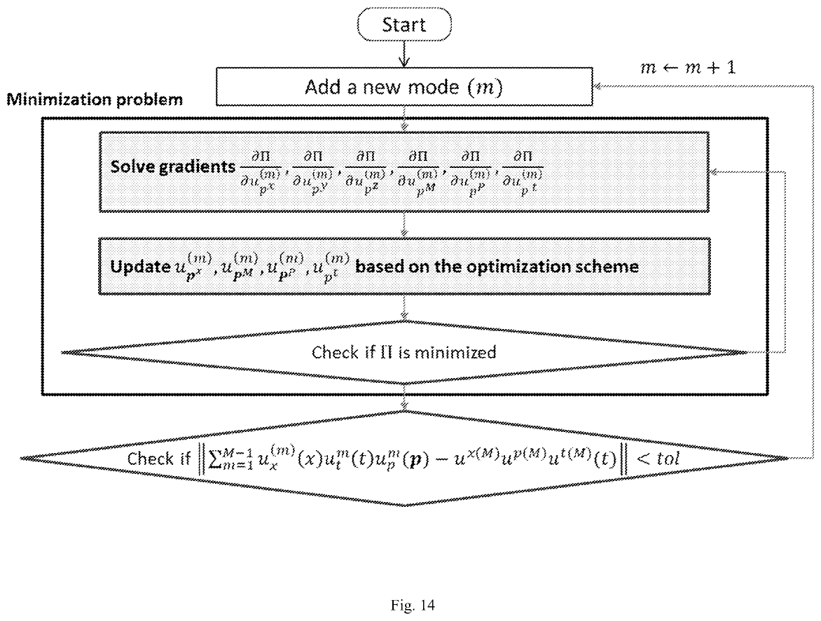

while fixing other five variables. A linear solver is used with multiple GPUs if applicable. Although the system of linear equations for each variable can be analytically derived, the same can be carried out using automatic differentiation which is available through modern machine learning programming languages such as PyTorch and Google JAX. The second solution scheme, minimization, is described in FIG. 14. Unlike the AFI algorithm where a system of linear equations is solved for each variable one by one, the minimization algorithm directly utilizes potential energy Π assuming that the potential energy for a given physical problem is defined. Compared to AFI, the minimization algorithm is more concise, and it is more suitable for implementing on multiple GPUs. However, the convergence of minimization problem can prolong depending on the optimization algorithm and the initial condition. A user needs to decide which algorithm will be suitable for specific problems.

### C-HiDeNN-AI System

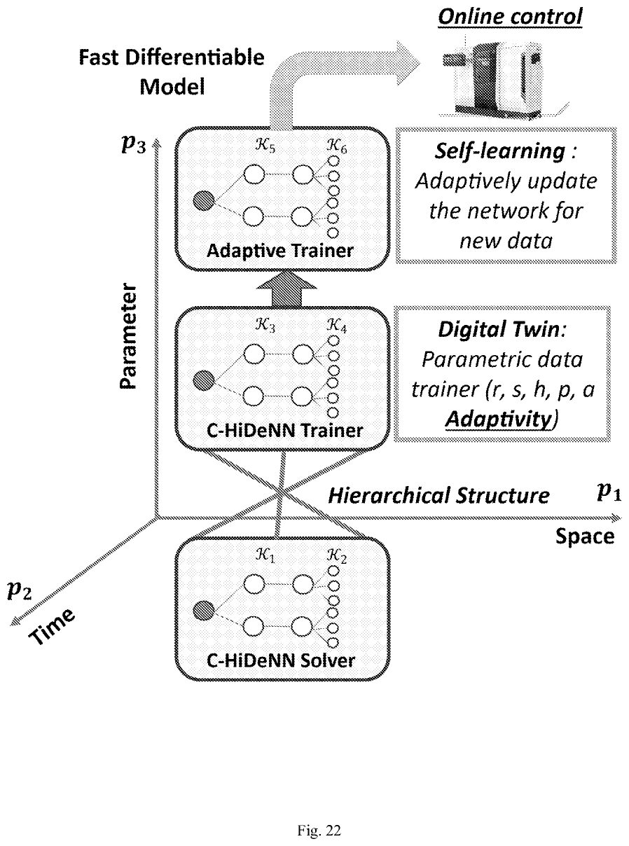

The vision of the C-HiDeNN-Artificial Intelligence (AI) system is to produce a digital twin that can be trained in real time on mobile devices. The vision of the C-HiDeNN trainer and solver is shown in FIG. 22. The space-time-parametric relationship between the input and output is expressed using kernel interpolation along each axis, following the philosophy of the tensor decomposition. The C-HiDeNN model is used later to generate a larger parametric database. A hierarchical neural network is developed based on custom connections. These C-HiDeNN trainers will have much more flexibility in terms of training. This can be achieved either by customizing the neural network from scratch or applying pruning. This tuning reduces the number of parameters to be trained, making the network consume less memory. Later, the tensor decomposition technique is applied to further compress the neural network.

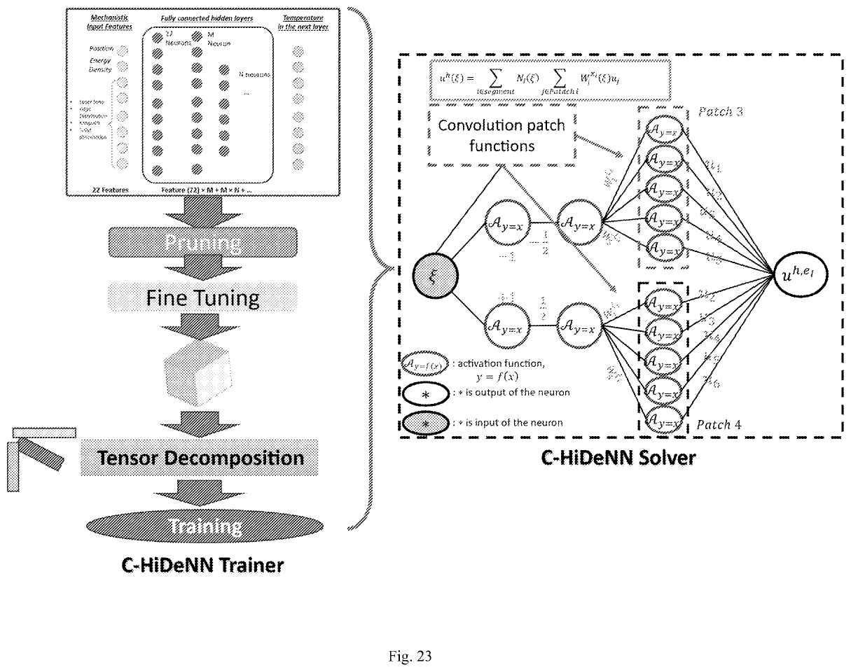

A comparative analysis of the C-HiDeNN trainer and solver is shown in FIG. 23. The goal is to create a sparse neural network structure keeping the accuracy high so that the training and application can be performed in a manufacturing machine. In the C-HiDeNN solver, the interpolation function is constructed using custom neural network blocks. In the figure, the activation functions control the degree of non-linearity in the interpolation and the convolutional patch functions define the support domain for the interpolation. Here, the support domain means how many basis points will be used for interpolation. To draw an analogy with a fully connected neural network, the patches are the connections among the neurons of the input layer. By controlling the number of connections (or patches), the number of parameters to be trained can be controlled. A proposed methodology to control the connections is shown in FIG. 23 under the tile C-HiDeNN trainer. As an example, the forward model is shown in the figure. The network has 22 input features, and each hidden layer has 150 neurons and there are three hidden layers. For a general network, the estimate of the parameters will grow as: Feature (22)×M+M×N+ . . . . To reduce the number of connections and trainable parameters, we apply a method called pruning first. In this method, we can identify the redundant weights and biases of the original fully connected neural network. The identified less important weights will be masked as zero value. Therefore, the parameter matrix will become very sparse. However, for sudden reduction of values in the parameters, the accuracy of the network will drop. To avoid that, we apply fine tuning. The fine tuning is essentially retraining the whole network with the newest set of parameters. After this step, we will apply the tensor decomposition of the parameter matric. This step will convert the parameter matrix into a set of low rank components (essentially vectors). Only a few preselected decomposed low rank vectors can essentially express the entire fully connected parameter matrix.

### C-HiDeNN-TD for Manufacturing Simulations

Space-time-parameter tensor decomposition can be used effectively to solve the high-dimensional partial differential equations in manufacturing problems, which can be generally described as:

$$( u ( {p}^{x} , {p}^{M} , {p}^{t} ) ) = 0 \qquad ( 26 )$$

where p^{x}=[x, y, z] is the spatial coordinates; p^{M} is material and processing parameter vector; p^{t} is the time parameter. In tensor decomposition (TD) theory, the solution field u is assumed to be decomposed by a finite sum of multiplications of 1D functions.

$$u = {\sum }_{m = 1}^{M} {u}_{{p}^{x}}^{( m )} ( {p}^{x} ) {u}_{{p}^{M}}^{( m )} ( {p}^{M} ) {u}_{{p}^{t}}^{( m )} ( {p}^{t} ) \qquad ( 27 )$$

In C-HiDeNN-TD theory, C-HiDeNN approximation is applied for each of the separated 1D functions, such as:

$${u}_{x} ( x ) = \tilde{N} ( x ) {u}_{x} , {u}_{t} ( t ) = \tilde{N} ( t ) {u}_{t} \qquad ( 28 )$$

$$δ {u}_{x} ( x ) = \tilde{N} ( x ) δ {u}_{x} , δ {u}_{t} ( t ) = \tilde{N} ( t ) δ {u}_{t}$$

where Ñ is the convolution shape function vector formed by the 1D convolution functions in a patch domain. uₓ are the associated nodal solution vectors in different spaces. Since only 1D convolution shape function is used, C-HiDeNN-TD has linear growth in terms of number of DoFs (degree of freedoms) whereas the conventional method has exponential growth in DoFs. Therefore, C-HiDeNN-TD has exceptional benefits for large scale problems. Solving solution vectors is defined as the offline stage of C-HiDeNN-TD theory.

Once the solution vectors are solved, C-HiDeNN-TD can be used effectively as an interpolator to obtain solution u for a new set of parameters. As a result, it is very useful for online control of manufacturing process since the new solution can be obtained on the fly whereas conventional methods require running the forward simulation again.

C-HiDeNN-TD for Solving High-Resolution Mesh with Complex Microstructure Features

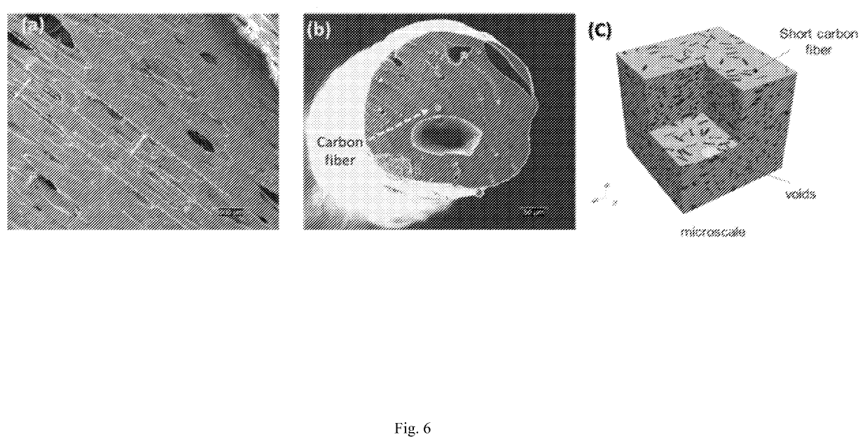

In one embodiment, C-HiDeNN-TD can be used for the predictive performance analysis advanced materials such as metal alloy, composites, ceramics, etc. Advanced manufacturing processes such as additive manufacturing are now used to process these materials by designing their microstructures at multiple length scales for optimal performance. C-HiDeNN method can model these complex microstructures with greater details and features such as defects at multiple length scales. An example of the complex microstructure from the additively manufactured polycarbonate/short carbon fiber composites are shown in FIG. 6.

Additively manufactured parts may fall short during the part qualification process, as their manufacturing process conditions affect the formation of material microstructures and introduce different types of defects. These defects are critical to the development of a predictive model of part performance. In FIG. 6, a representative volume element of the microstructure is shown considering the voids and 10% short carbon fiber distribution with 1 million voxel mesh. Solving 1 million degrees of freedom (DoFs) using a conventional computational approach (e.g., FEM) takes a long time. However, this 1 million DoFs mesh is not sufficient to reconstruct the details of the microstructure. A higher resolution is necessary to resolve this finer scale of the microstructure to predict the microscale damage mechanisms such as void growth, void coalescence and fracture mechanism. C-HiDeNN-TD enables the analysis of higher resolution models with complex microstructure to study the key governing physics in the lower length-scales. C-HiDeNN-TD can be applied to solve a RVE scale with a finer resolution mesh that will reveal the governing mechanism.

### C-HiDeNN-TD for Identifying Structure-Property-Performance Linkage

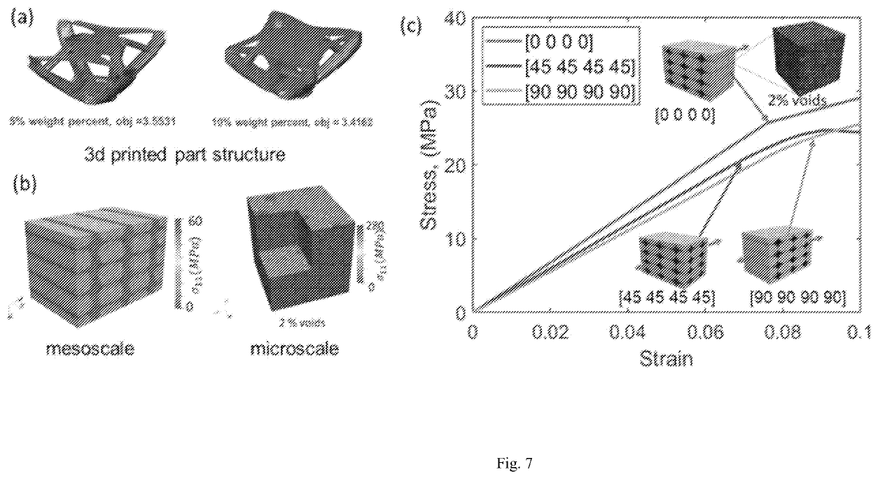

In one embodiment, C-HiDeNN can be used for the predictive performance analysis to understand the relationship among the complex microstructure to their properties and performance at multiple length scales. As shown in FIG. 7, an additively manufactured drone structure with different weight reductions can be designed with different layer orientations at the meso-scale level. A concurrent analysis of all the scales is crucial to understand the defects interaction among the scales and the fracture mechanism of the parts. The multiscale C-HiDeNN-TD formulation developed in this patent disclosure can be applied to predict the performance of an additively manufactured part considering the mesoscale and microscale materials microstructures with defects. Considering the high-dimensional design space in composite additive manufacturing, C-HiDeNN-TD can be combined with mechanistic reduced-order model (ROM) such as self-consistent clustering analysis (SCA). The high-resolution microstructures features can be resolved by leveraging C-HiDeNN-TD in the offline stage of the SCA, forming a three-scale problem C-HiDeNN-TD/SCA/SCA for part/meso/micro scale. This kind of analysis yields better accuracy and serve as a predictive performance analysis tool for the rapid prototyping.

### C-HiDeNN-TD for High Resolution and Multiscale Topology Optimization of Additively Manufactured Materials Performance

The present invention develops a multiscale topology optimization leveraging the C-HiDeNN-TD theory to break the curse of dimensionality in high-resolution, and concurrent multiscale topology optimization problems. Topology optimization algorithms search for the most efficient design within a specified domain given a set of constraints. In the context of structural topology optimization, the domain is a region where material may be allocated, while constraints and design efficiency are often defined in terms of quantities of interest, such as volume fraction, stiffness, toughness, and maximum stress. Topology optimization methodologies are well developed and are already used to speed up the product design cycle while resulting in superior product performance and reduced costs and material waste. Their appeal stems from their tremendous design freedom and ability to produce good results without a meaningful initial configuration.

Despite their popularity, the algorithms still pose many challenges related to the feasibility of results and numerical difficulties. For practical-scale formulations, the computational expense of traditional topology optimizations is prohibitive. Furthermore, resulting designs may be impossible to implement due to their complexity at small length scales or the existence of intermediate density elements, a non-physical artifact of the conventional Solid Isotropic Material with Penalization (SIMP) method. Many attempts to push the optimizations towards more feasible designs resulted in an increased number of DoFs. Topology optimization algorithms use a solver to calculate the mechanical responses, which then get passed to an optimizer that will update the structure. The solver step in the topology optimization takes the most computing time and becomes more computationally expensive as the resolution increases.

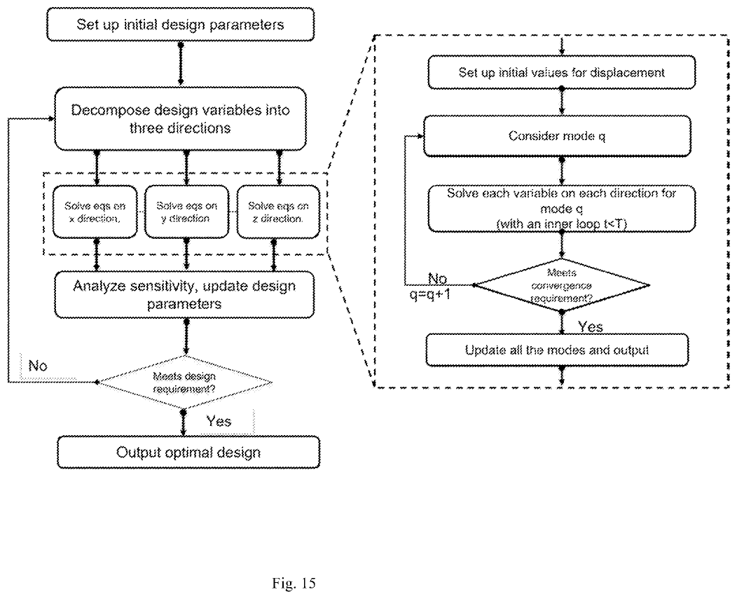

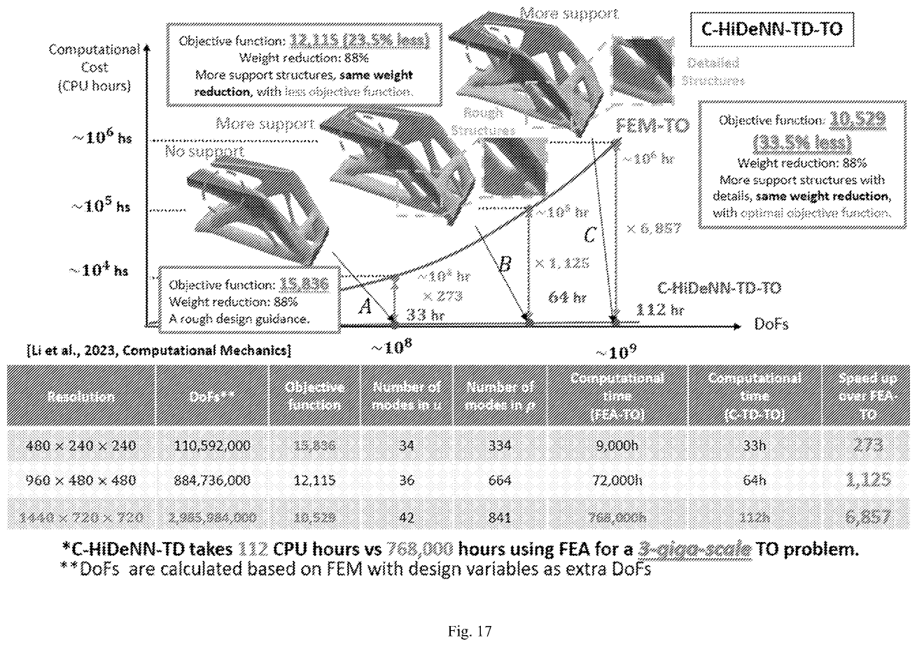

C-HiDeNN-TD can overcome the enormous computational expense of large-scale topology optimizations by decomposing multidimensional problems into several, much cheaper to solve, one-dimensional problems. A flowchart of topology optimization with C-HiDeNN-TD solver is shown in FIG. 15. Dividing a large multidimensional problem into single dimensional subproblems reduces each iteration's computational burden and decreases the memory requirement. As shown in FIG. 17, using C-HiDeNN-TD-TO, the previous supercomputer-based problem can be easily solved by a single PC and reduce CPU time from 9,000 hours to 33 hours. The C-HiDeNN-TD-TO of the present invention extends the computational and design capability far beyond current computer power limit to 10¹⁶ DoFs, which is intractable using traditional FEM-TO. The significant decrease of computing cost enables an efficient concurrent multiscale optimization, which is developed in the following.

Convolution Interpolation for Built-In Density Filtering and Higher-Order Density Smoothness without Extra DoFs

In TO with the Solid Isotropic Material with Penalisation (SIMP) approach, the design variable, i.e., density field, is considered constant inside each element of the background mesh. Let Le denote an element region. The SIMP-based density description is defined as

$${ρ}^{SIMP} ( ξ ) = {ρ}_{e} , ∀ ξ ∈ {Ω}_{e} . \qquad ( 29 )$$

Consequently, the SIMP approach can lead to discontinuous density distributions and checkerboard patterns across multiple elements. Using higher-order elements for a smooth description of the density field is one of the solutions to resolve this issue. However, using higher-order finite elements can result in excessive increases in the computational cost of TO due to the additional DoFs in both the physical equations and the design variables. Another way to mitigate checkerboarding and enforce length-scale control is the filtering technique. Several filter methods have been developed, including sensitivity filter, density filter, Heaviside filter, and averaging filter. However, the extra filtering stage increases the computational burden in the design loop, especially for high-resolution problems where the filter may be applied over millions or billions of DoFs. From the above perspectives, the C-HiDeNN approximation is advantageous in providing a built-in filter to improve the design smoothness without increasing the overall number of design variable DoFs and DoFs of the numerically discretized physical system. Therefore, the proposed C-HiDeNN-TD-TO framework is expected to lead to a higher-order smooth density description compared to SIMP if the same background mesh (resolution) is used. The C-HiDeNN approximated density field can be defined using the nodal values of the background mesh. Similar to the displacement field, the nodal density can be denoted by ρⱼ, and the approximated density then reads:

$${ρ}^{C - H i D e N N} ( ξ ) = {\sum }_{i ∈ {A}^{e}} {N}_{i} ( ξ ) {\sum }_{j ∈ {A}_{s}^{i}} {W}_{a , p , j}^{{ξ}_{i}} ( ξ ) {ρ}_{j} = {\sum }_{k ∈ {A}_{s}^{e}} {\tilde{N}}_{k} ( ξ ) {ρ}_{k} , \qquad ( 30 )$$

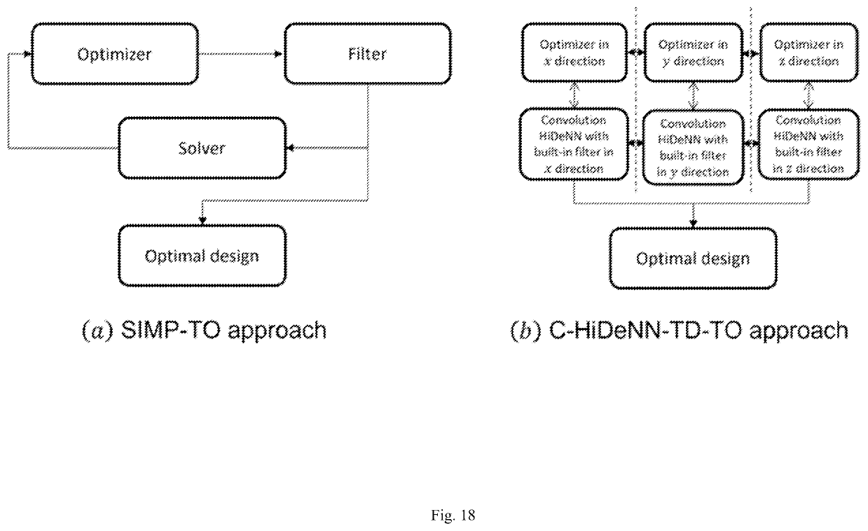

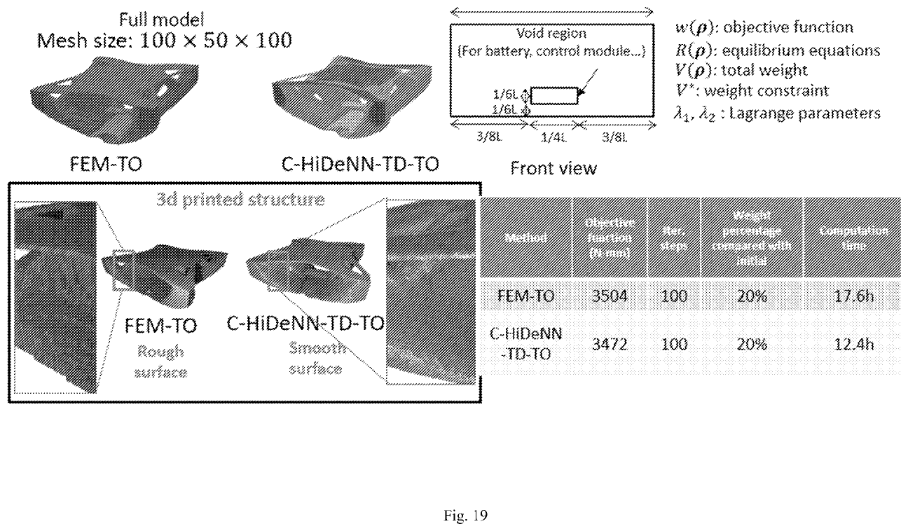

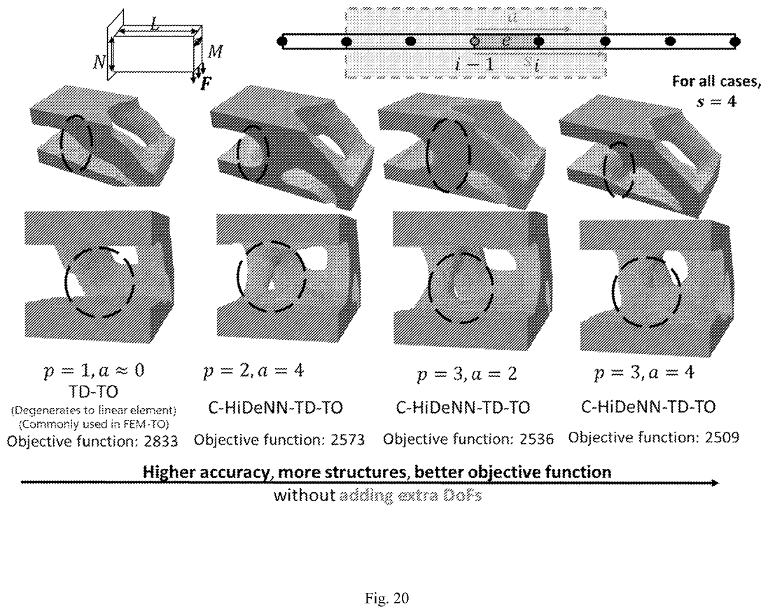

The dilation parameter a, the polynomial order p, and the patch size s serve as built-in filtering parameters to control the minimum design length-scale and remove checkerboard patterns. FIG. 18 shows the difference between the SIMP-TO approach and the C-HiDeNN-TD-TO approach. Unlike SIMP-TO, the density is interpolated using C-HiDeNN-TO shape functions and the convolution operation serves as a filter on the density field, which will automatically prevent checkerboarding and incur length-scale control. FIG. 19 shows C-HiDeNN-TD enables the design to have arbitrary smoothness without adding extra DoFs, compared to FEM-TO. In addition, as shown in FIG. 20, by adjusting the dilation parameter a and polynomial order p, C-HiDeNN-TD-TO achieves better performance while keeping the same DoFs.

### C-HiDeNN-TD Method Enables Concurrent Multiscale Topology Optimization.

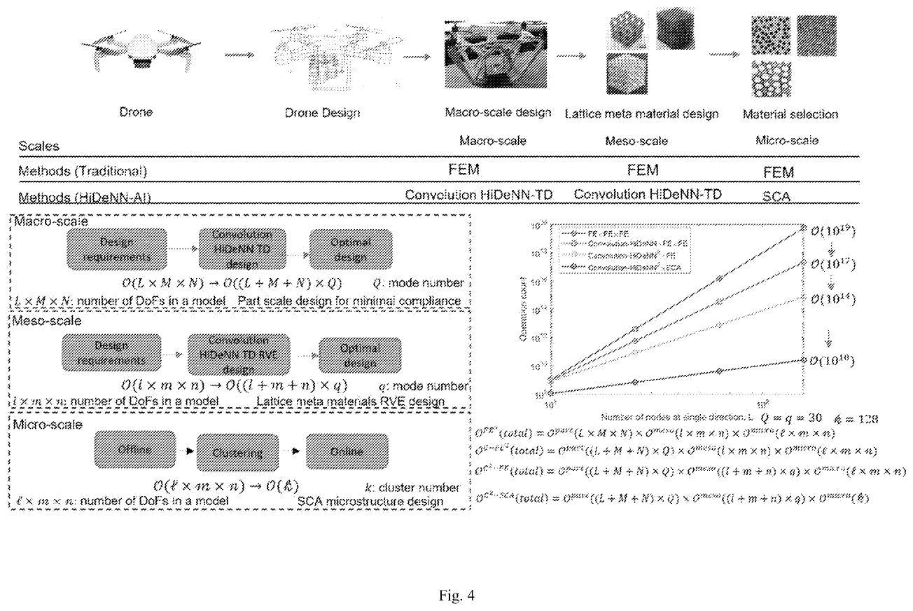

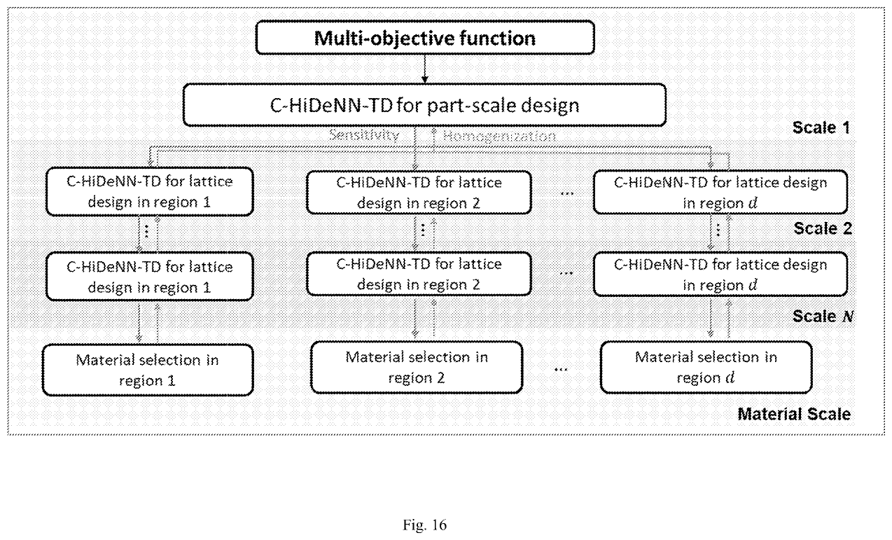

In one embodiment, the C-HiDeNN-TD² is developed, as shown in FIG. 4 with macro-scale and meso-scale, and in FIG. 16 for the flowchart. For the macro-scale, the C-HiDeNN-TD of the present invention can solve the optimization problem. For the meso-scale, a concurrent C-HiDeNN-TD² method produces designs of material lattice structures. The C-HiDeNN-TD² can reduce the computational cost at two scales simultaneously, which gives a tremendous computational complexity reduction from [symbol] (10¹⁹) to [symbol] (10¹⁴) for a given concurrent design problem. Theoretically, adding additional scales is possible, as illustrated in FIG. 16.

C-HiDeNN-TD Method can be Applied to Design n-Scale Hierarchical Materials

The concurrent multi-scale TO can be further extended to a clustering-based reduced order model. For example, at the micro-scale, a clustering reduced order method, self-consistent clustering analysis (SCA), is linked with the upper scales for concurrent material microstructure design. The SCA has two stages: offline stage and online stage. After offline database preparation, the online stage provides a fast prediction of the material nonlinear property prediction. From the nonlinear responses, the optimal material microstructures will be chosen, such as those with high toughness or fracture resistance. The SCA method is linked with the C-HiDeNN-TD² to provide design guidance for feasible material microstructures. By implementing the proposed framework, the operation count can be reduced from [symbol] (10¹⁹) for traditional FEM³ to [symbol] (10¹⁰) using C-HiDeNN-TD²-SCA, as shown in FIG. 4. The proposed framework can be extended to n-scale design, where domains at any number of scales may be concurrently explored to find good designs using affordable computational resources.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

Some references, which may include patents, patent applications and various publications, are cited and discussed in the description of this invention. The citation and/or discussion of such references is provided merely to clarify the description of the invention and is not an admission that any such reference is “prior art” to the invention described herein. All references cited and discussed in this specification are incorporated herein by reference in their entireties and to the same extent as if each reference was individually incorporated by reference.

What is claimed is:

1. A forward engineering analysis method of Convolution-Hierarchical Deep-learning Neural Network-Tensor Decomposition (C-HiDeNN-TD) for solving a physics problem using more than one graphics processing units (GPUs) or tensor processing units (TPU) combined with multiple CPUs, comprising:
(1) providing a plurality of modes and at least one C-HiDeNN parameter;
(2) computing at least one C-HiDeNN function for each of the plurality of modes based on the at least one C-HiDeNN parameter;
(3) solving the physics problem for each of the plurality of modes based on the C-HiDeNN function;
wherein the at least one C-HiDeNN function comprises a spatial C-HiDeNN function;
wherein the C-HiDeNN parameter comprises at least one of a patch size s, a dilation parameter a, and a reproducing order p.

2. The forward engineering analysis method of C-HiDeNN-TD of claim 1, wherein the at least one C-HiDeNN function comprises at least one of a material C-HiDeNN function, a process C-HiDeNN function, and a temporal C-HiDeNN function.

3. The forward engineering analysis method of C-HiDeNN-TD of claim 2, wherein the spatial C-HiDeNN function is
$${u}_{{p}^{x}}^{( m )} ( {p}^{x} ) .$$

4. The forward engineering analysis method of C-HiDeNN-TD of claim 3, wherein the material C-HiDeNN function is
$${u}_{{P}^{M}}^{( m )} ( {p}^{M} ) .$$

5. The forward engineering analysis method of C-HiDeNN-TD of claim 4, wherein the process C-HiDeNN function is
$${u}_{{P}^{P}}^{( m )} ( {p}^{P} ) .$$

6. The forward engineering analysis method of C-HiDeNN-TD of claim 2, wherein the temporal C-HiDeNN function is
$${u}_{{P}^{t}}^{( m )} ( {p}^{t} ) .$$

7. The forward engineering analysis method of C-HiDeNN-TD of claim 1, wherein the steps (2-3) are parallelizable with the more than one GPUs or the tensor processing units (TPU) combined with the multiple CPUs.

8. The forward engineering analysis method of C-HiDeNN-TD of claim 1, wherein the step (3) comprises an alternating fixed-point (API) iteration or a minimization of loss function.

9. The forward engineering analysis method of C-HiDeNN-TD of claim 8, wherein the loss function is uniquely defined based on a physics character of the physics problem.

10. A method for solving a concurrent multiscale topology optimization problem using Convolution-Hierarchical Deep-learning Neural Network-Tensor Decomposition (C-HiDeNN-TD) to produce a final design, comprising:
(1) providing at least one engineering target property; at least one design constraint, at least one material choice, a number of scales to be solved, and a design parameter;
(2) providing an initial domain mesh for each of the scales;
(3) formulating a multi-objective function and a convergence criteria based on the at least one engineering target property; the at least one design constraint; and the at least one material choice;
(4) performing a concurrent multiscale engineering simulation using a C-HiDeNN-TD parameter;
(5) analyzing a sensitivity character of the concurrent multiscale topology optimization problem;
(6) updating the design parameter; and
(7) outputting the final design when the convergence criteria is fulfilled;
wherein the C-HiDeNN-TD parameter comprises at least one of a patch size s, a dilation parameter a, and a reproducing order p.

11. The method for topology optimization using C-HiDeNN-TD of claim 10, wherein the target property comprises at least one of system compliance, stiffness or rigidity, Eigenfrequency or natural frequency, thermal performance, fluid flow characteristics, and electromagnetic characteristics.

12. The method for topology optimization using C-HiDeNN-TD of claim 10, wherein the design constraint comprises at least one of volume fraction, stress or strength constraints, displacement or deformation constraints, manufacturing constraints, buckling or stability constraints, frequency and resonance constraints.

13. The method for topology optimization using C-HiDeNN-TD of claim 10, wherein the material choice comprises at least one of metal, ceramic, polymer, and composites.

14. The method for topology optimization using C-HiDeNN-TD of claim 10, wherein the multi-objective function in step (3) is assigned to different regions in each of the scales.

15. The method for topology optimization using C-HiDeNN-TD of claim 10, wherein the concurrent multiscale engineering simulation in step (5) comprises conducting an engineering analysis in each scale concurrently.

16. The method for topology optimization using C-HiDeNN-TD of claim 15, wherein the engineering analysis in each scale is conducted using the C-HiDeNN-TD.

17. The method for topology optimization using C-HiDeNN-TD of claim 10, wherein the sensitivity analysis in step (5) is performed in parallel.

18. The method for topology optimization using C-HiDeNN-TD of claim 10, wherein steps (6-7) are performed in parallel.

19. The method for topology optimization using C-HiDeNN-TD of claim 10, wherein a C-HiDeNN-TD build-in filter is used to output a smooth design surface.
